(19) United States
(12) Patent Application Publication
(10) Pub. No.: US 2024/0395162 A1
(43) Pub. Date: Nov. 28, 2024

(54) AI training paradigm based on Personalized Heuristic QA 3D Self-study Method trains AI for Personalized education and General Rational AI System: Hybrid AGRINN (Artificial General Rational Intelligent Neural Network)

(71) Applicant: Wendy Wusan Xi, Superior, CO (US)

(72) Inventor: Wendy Wusan Xi, Superior, CO (US)

(21) Appl. No.: 18/395,736

(22) Filed: Dec. 25, 2023

Related U.S. Application Data
(60) Provisional application No. 63/468,783, filed on May 24, 2023.

(51) Int. Cl. G09B 7/00; G06F 40/40; G06N 3/0895

(52) U.S. Cl. CPC G09B 7/00; G06F 40/40; G06N 3/0895

(57) ABSTRACT

XI Personalized Heuristic QA 3D Self-Study Method provides systematic training through personalized heuristic question-answer iterations and 3D (vertical, horizontal and application) integration learning, tutoring learners to effectively learn on their own: acquire knowledge, understand underlying rules, fill in gaps in prior studies, and build up learners' self-Study ability. XI paradigm based on the method trains an LLM for personalized education, deductive reasoning, problem-solving, Integration-Innovation system: Hybrid AGRINN (Artificial General Rational Intelligent Neural Network). The system comprises a white-box AGRINN and a black-box AGRINN trained through it. The white-box AGRINN comprises three layers: ARICNN (Artificial Rational Intelligence Central Neural Network), Integration Hubs and Clustered Modules. ARICNN comprises Knowledge, Rule, Tool and Method subnetworks. Each Clustered Module is a template supported adaptable unit with clusters of QA-iterations, tutoring learners to tackle specific problem types and their variations. Each Integration Hub links a group of clustered modules that utilizes common elements of ARICNN.

### BACKGROUND

### 1. Personalized Education

Personalized education applications/tutors have two levels:
Level I: Personalized teaching helps learners acquire knowledge (receiving fish).
Level II: Personalized tutoring helps learners autonomously acquire knowledge and develop self-learning abilities (learning to fish and receiving fish).

Level II is the fundamental and final goal of education, as Einstein said: “The education is not the learning of facts, but the training of the mind to think”. This is especially crucial in today's era of information explosion, knowledge is constantly updated and never-ending. If we teach learners how to learn, they not only acquire knowledge (the “Fish”) but also learn how to self-educate and obtain knowledge (the “Fishing”). This lifelong ability enables them to solve problems they did not learn about in school.

Currently, most teachers and educational applications provide the step-to-step solution with or without explanation. “The current state of the art is Khanmigo, a text-based bot created by Khan Academy. It can tutor students in math, science, and the humanities—for example, it can explain the quadratic formula and create math problems to practice on” (Bill Gates, Nov. 9, 2023).¹ Although Khanmigo is developed on GPT-4 with their decades of teaching experience at the highest level in the world, it only reached a certain extent of Level I of Personalized education. ¹ https://www.gatesnotes.com/AI-agents

Through years of volunteering to tutor students with learning difficulties in mathematics, I have developed a unique approach called the Personalized Heuristic QA 3D Self-Study Method (XI method). I have tutored several dozen students in China and the United States using the method. The majority of them, aside from a few A students, were D or below, with many experiencing conditions such as low IQ, autism, ADHD (attention deficit hyperactivity disorder), and or Dyslexia (difficulties in reading and writing), mildly impaired working memory. After about 10 hours or less of training and 20-30 hours or less of exercises, all students have made significant progress. Normal students went from D students to B or A students, and students with learning difficulties can learn things that teachers, parents and training institutions have been unable to teach them for years. Not only did they learn the knowledge, but their learning abilities in mathematics and other areas also improved significantly. The ultimate goal of the method is to enable self-study.

Using this method to train an LLM (Large Language Model) enables it to provide the Personalized Heuristic QA 3D Self-Study educational service.

In everyday life in ordinary households, the two most in-demand AI products are personalized tutoring and household robots. While individuals can manage household chores without robot assistance, many parents lack the professional knowledge and ability to effectively guide their children.

### 2. AI Training Paradigm

Currently, the most advanced AI applications are black box applications, which are challenging to explain, control, and align with human values before they reach uncontrollable levels. The XI training paradigm is a white-box training based on the XI method, which neural network systems and applications are explainable, consistent, controllable, responsible, and have the deductive reasoning and First principle reasonings required by rigorous scientific theories that existing AI lacks.

### SUMMARY

### 1. Personalized Heuristic QA 3D Self-Study Method

The Personalized Heuristic QA 3D Self-Study Method (XI method) provides systematic training through Personalized Heuristic Question-Answer iterations and 3D (Vertical, Horizontal and Practical) integration learning. As shown in FIG. 5, all knowledge intertwines to construct a multifaceted learning framework akin to a three-dimensional structure. Using 3D Study instead of 3D learning is because it is not only used for structured education in schools, but also for autonomous exploration and research. This method uses the learning principles listed in FIG. 1, guiding learners to effectively learn on their own: acquiring knowledge, understanding the underlying principles, filling in gaps in previous learning, and building learners' self-study ability through mastery of these principles.

### 2. WB-AGRINN (White Box AGRINN)

Applying XI method as a white-box AI training paradigm to an existing LLM to create a WB-AGRINN. It shares structural and functional similarities with the “small-world topology” of the human brain, which is characterized by highly connected hubs and modularity. The training builds up the LLM's deductive and First principles reasonings which the LLM does not have, and also enhance its existing reasonings (probabilistic reasoning, analogical reasoning, inductive reasoning, and abductive reasoning).

WB-AGRINN consists of three layers of subnetworks: ARICNN (Artificial Rational Intelligence Central Neural Network), Integration Hub and Cluster Module. The ARICNN comprises four subnetworks, Knowledge, Rule, Tool and Method. Each Clustered Module is a template supported adaptable unit with clusters of QA-iterations, guiding learners to tackle specific problem types and their variations. Each Integration Hub links a group of clustered modules that utilizes common elements of ARICNN in problem-solving.

XI training from scratch uses multiple problems of each different type, distills them into a unified source type, models them into CMs, and automatically templates them. The system uses the Scaling-Template mechanism to perform the reasoning and computation process, and utilizes the Rational Network Flowchart (RNF) to solve complex network data structure problems. The network data structure, with its intra-tree and cross-tree intertwined branches, is significantly more complex than those solvable by Chain-of-Thought (Wei et al., 2023) and Tree-of-Thought method (Yao et al., 2023).

### 3. Self-Trainings and Hybrid AGRINN

WB-AGRINN undergoes self-training to automatically generate N variants of a source type based on templates, for various scenarios, and links synthesized text data to multimedia data. Then, it trains the student AI with multimodal data to seamlessly integrate scientific reasoning with visual understanding, enhancing its QA iterations and the ability to dynamically generate personalized multimedia data.

WB-AGRINN self-trains itself and BB-AGRINN (black box AGRINN) Integration-Innovation ability to generate new approaches, pathway, insights, etc.

WB-AGRINN and BB-AGRINN form a Hybrid AGRINN which is an advanced general problem-solving, Integration-Innovation, and an approximate solver for universal functions of different dimensions.

### 4. Personalized Heuristic QA 3D Self-Study Educational Service

One major application of the Hybrid AGRINN is its use in providing the Personalized Heuristic QA 3D self-study educational service. It has the following advantages:
It uses the XI method to tutor leaners to acquire knowledge and build up self-study ability on their own. The service never provides step-by-step solutions for students to copy, addressing the issue of students merely copying answers from AI applications without truly understanding and mastering the knowledge.
It is applicable to all disciplines that require rational intelligence, including social sciences, although the dozens of XI training examples in the application are focused on math and logical training. It is suitable for all types and levels of education, including university, vocational, and lifelong learning.
Once developed, it can be translated into multiple languages, offering learners the opportunity to simultaneously study subjects and new languages.
This educational service unlocks personal potential through tailored learning, nurturing unique skills, and igniting a spirit of growth amidst friendly competition. For example, a student could participate in K-5 math and K-7 English based on their diverse strengths and talents, enabling them to excel in their areas of expertise. Competing against peers at similar levels maintains excitement and motivates students to pursue greater achievements without feeling overwhelmed by excessive peer pressure.
Although the educational service encompasses subjects at various levels, with minimal additional development effort, it can also be decomposed into various lightweight standalone applications customized for learners at different levels, such as K1-K5. The applications can be run on various types of user devices without incurring the operational costs typically associated with cloud servers

### 5. Social Benefit

This product can bring significant benefits to society, including promoting educational equity, supporting special education for those with learning difficulties, low IQ, ADHD, and autism; reducing crime rates; alleviating population decline caused by the pressure of educational costs in various countries; and enhancing the dignity of human life. For more detailed information, please refer to Appendix A.

### 6. Cost and Profit

As it is built upon an advanced existing LLM application, the development cost is limited. The educational service in K12 mathematics alone (not including other subjects) is expected to generate billions of dollars in profits annually from the United States and around the world (even with no charge to poor countries and individuals). The current subscribers of the existing LLM product will increase N-fold.

### BRIEF DESCRIPTION OF THE DRAWINGS

FIG. 1 shows XI Training paradigm, components and Learning principles.

FIG. 2 shows an example of Knowledge subnetwork and the XI QA training flowchart.

FIG. 3 shows QA iteration data structure.

FIG. 4 shows the three layers of WB-AGRINN system and the components.

FIG. 5 shows an example of 3D study.

FIG. 6 shows Hybrid AGRINN and its educational service domain.

FIG. 7 shows an example of a Rule subnetwork.

FIG. 8 shows an example of Method subnetwork.

FIG. 9 shows an example of Tool subnetwork.

FIG. 10 shows an example of Rational Network Flowchart (RNF) which is the solution of the CM for the logic pre-training problem F.1 in Appendix D.

FIG. 11 shows XI AI training system, components and flowchart.

FIG. 12 An example of IH and CM connection types and configuration.

FIG. 13 shows the process of Data buildup and templating.

FIG. 14 shows the targeted reasoning levels outlined with the examples in problem-solving.

FIG. 15 shows XI AI self-training flowchart on the Hybrid AGRINN System.

FIG. 16 shows AI Creative Reasoning Tests and Evaluation flowchart.

### DETAILED DESCRIPTION

### 1. XI Method: Learning Principles, System Components and Outline

### 1.1 Learning Principles

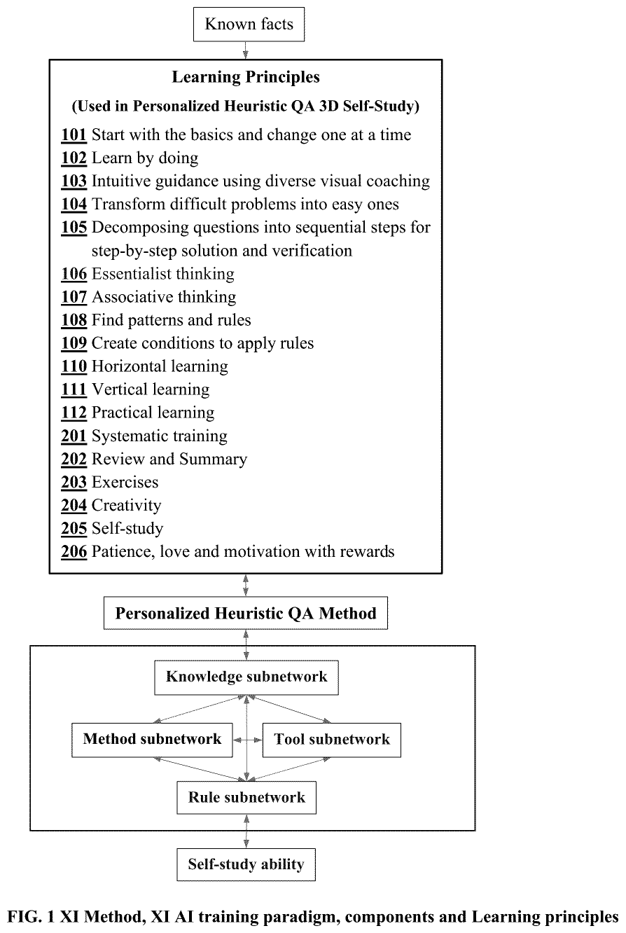

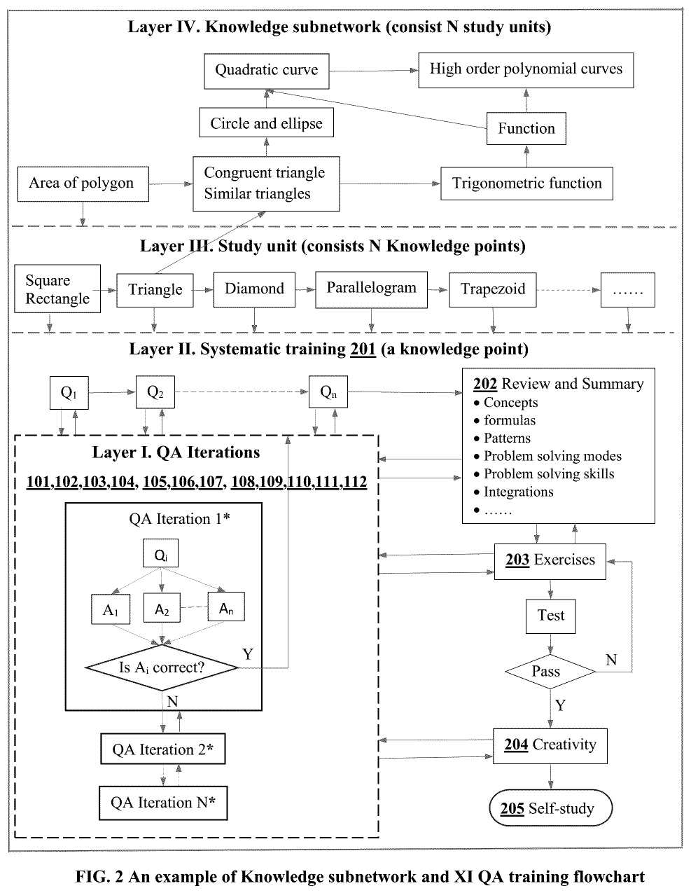

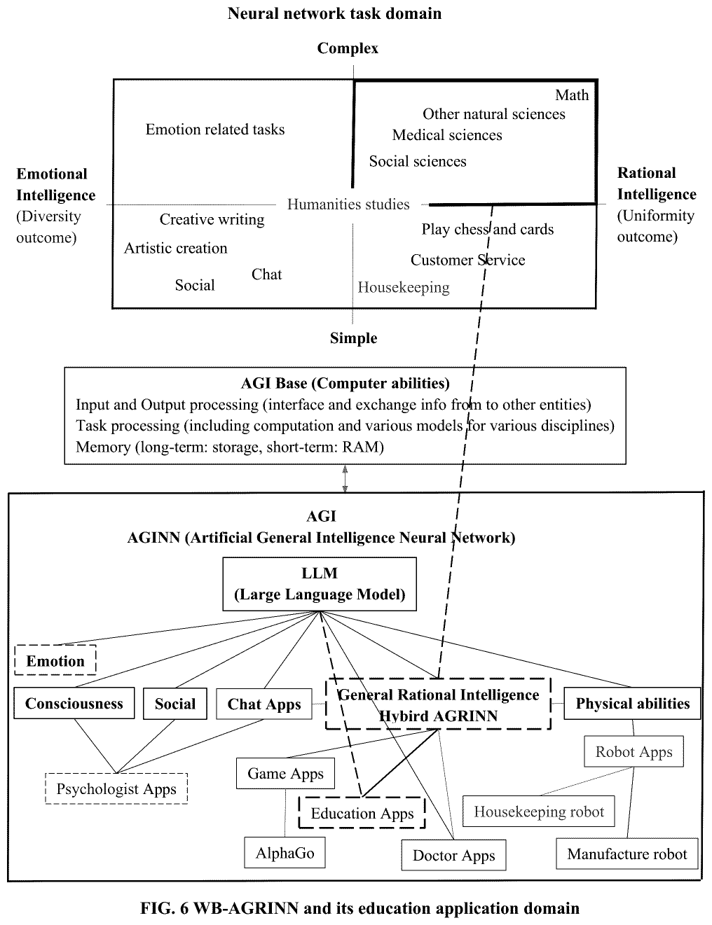

As shown in FIG. 1 and FIG. 2, the Learning principles identified by underlined numbers are the fundamental guidelines for the XI method and XI training paradigm. Appendixes B, C and D provide extensive examples to demonstrate the practical application of these principles. These examples focus solely on cases involving learners experiencing difficulties mentioned in the background section, omitting cases related to high-achieving students. Cases B1 and B2 in Appendix B serve as introductory examples of the XI method, combining several Learning principles to provide an overview of the approach. The examples in Appendix B are from my personal practice, while the examples in Section 6, Appendix C and D are for AI training using the XI paradigm. Although all examples and descriptions are based on mathematical disciplines, as shown in FIG. 6, the XI method and XI training paradigm are applicable to all disciplines related to rational reasoning.

### 1.2 XI System Description

As shown in FIG. 2, the system consists of four layers.

### (1) Layer IV: Knowledge Subnetwork (Consist N-Study Units)

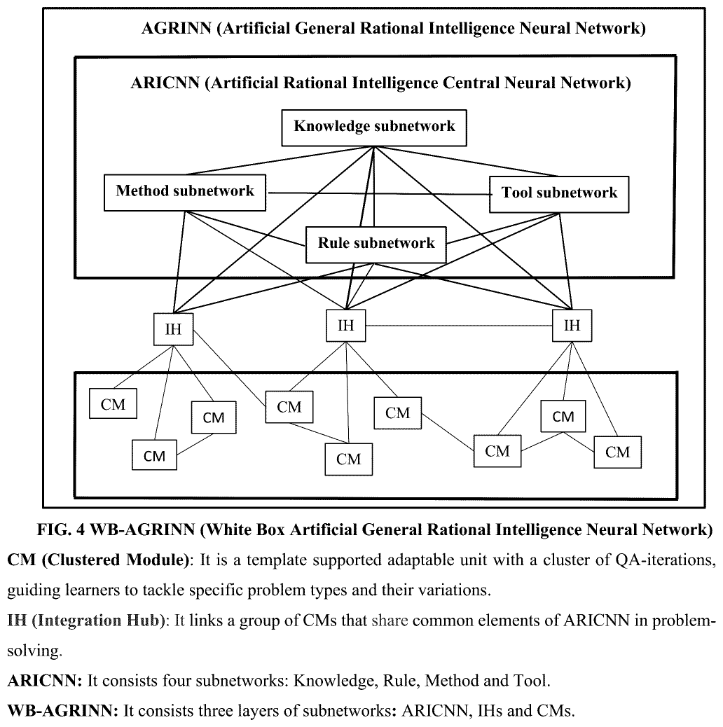

Each Study unit is connected to the knowledge subnetwork as shown FIG. 2. The knowledge subnetwork is one of the subnetworks in ARICNN shown in FIG. 4.

### (2) Layer III: Study Unit (Consist N-Knowledge Points)

A Study unit consists N Knowledge points ranked from easy to difficult.

### (3) Layer II. Learning Block of a Knowledge Point

FIG. 2 outlines the flowchart of the learning blocks, and examples are provided in Appendix D. These processes interact with each other and QA iterations.

### 202 Review and Summary

Review and summary are set before 203 exercises. The reason is that if learners do not digest what they have learned through review and summary on their own before doing homework, most of them may simply copy the solution path of the examples they have learned, and then quickly forget it. The summary will be supplemented and enhanced during the exercises.

### 203 Exercises

Some of the questions in the exercises are more challenging than the examples in the learning process. Only through challenging questions can learners truly and deeply understand and apply what they have learned.

### Test

Problems found in the test will be analyzed and looped back to the 202 Review and Summary and 203 Exercises processes.

### 204 Creativity

One of the best methods to reinforce learned knowledge and foster creativity is to use acquired knowledge to create new problems.

### 205 Self-Study

This is the end of this knowledge point and the beginning of the next learning block. Learners are always required to learn new knowledge points on their own.

All processes can be done with the help of QA iterations.

### (4) Layer I: QA Iteration

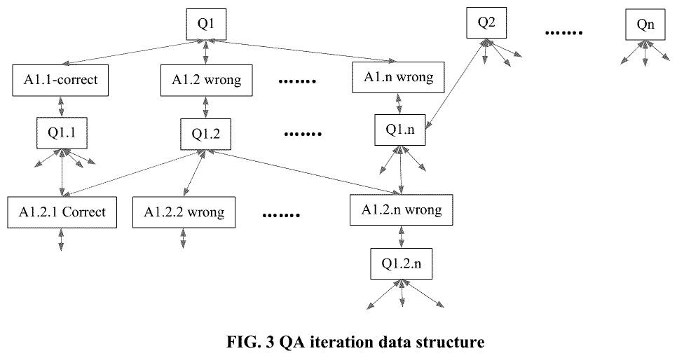

It is the basic work block of QA. As shown in Cases B1 and B2, for questions in learning, learners are asked to answer a question to solve the problem.
If the learner cannot answer a question, present them with a lower-level question until they can answer. Then, step by step, work back up to the initial question until it is resolved. As shown in FIG. 2 and FIG. 3, the QA data structure is such that a knowledge point can have multiple QA trees, each QA tree can trigger multiple QA iterations, and the branches of the trees can be interconnected.
During this process, any gaps in previous learning identified from the wrong answers can be addressed, as shown in Case B1.
In higher-level study units, even if we may not expect learners to derive formulas or theorems themselves, a heuristic QA process can be used to identify gaps in learners' understanding of concepts and theorems, as shown in Case B6: Understanding theorems for a K5 student.

### 1.3 3D Study

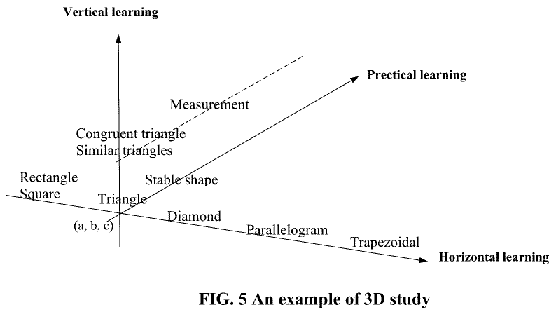

As shown in FIG. 5, the knowledge framework has a 3D (vertical, horizontal and practical) structure.

### 110 Horizontal Learning (Transfer Learning)

As shown in Case B28 and Case B29, it leverages prior knowledge and skills to teach oneself similar or more advanced topics.

### 111 Vertical Learning

As shown in Case B30, it connects foundational concepts taught at lower levels of education with more advanced concepts introduced at higher levels. This approach helps students build a cohesive understanding of a subject as they progress through their studies.

### 112 Practical Learning

As shown in Case B31 and Case B38, it involves applying acquired knowledge. Case B31 exemplifies this through interdisciplinary knowledge application, while Case B38 shows that the learner is able to learn deeply by creating more complex problems than those in the textbook.

### 1.4 How the System Works for Learners at Different Levels

For Learners with Learning Difficulties

Applying QA iterations to each knowledge point in the syllabus until learners reach a level of competency equivalent to that of their peers. This system may be particularly beneficial for special education students and those with lower IQ.

### For Ordinary Learners

Start with a QA learning to master foundational learning skills, then transition to self-study with the support of QA iterations. For example, the below-average student in Case B1 could derive the formula for the area of an obtuse triangle after a QA leaning session.

### For Outstanding Learners

These learners usually need little guidance after reading the textbook. The main help for them is to develop logical thinking and reasoning by solving complex problems. The platform should allow uploading of complex questions and provide real-time AI-driven QA sessions for coaching. This is the most challenging aspect of the product. Any new types of questions during these live sessions can be added to the system database.

### 2 Black-Box and White-Box AI Neural Network Systems and Application Domain

### 2.1 Human Brain Networks

Two important components of the human brain's neural network are neurons and synapses (the connections between neurons).
(a) Neurons. The estimated number of neurons in an adult brain is typically around 86 billion (Herculano-Houzel, 2016).
(b) Synapses. Each neocortical neuron has an average of 7,000 synaptic connections (Drachman, 2004).

The neocortex is a part of the cerebral cortex and is involved in higher-order brain functions such as sensory perception, generation of motor commands, spatial reasoning, conscious thought, and language.
(c) Structure. The brain network structure is characterized by highly connected hubs and modularity. Connector hubs in the brain enhance network modularity, which improves task performance and tunes the connectivity of their neighbors to be more modular (Bertolero, et al., 2018).
(d) Neuroplasticity. When we learn new things, the neurons in our brains continuously adjust and optimize the strength of their connections through synapses, resulting in increased efficiency and effectiveness. This optimization leads to a significant reduction in the number of synapses compared to childhood.² 2 The estimated number of synapses of a three-year-old child has about 1015 synapses (1 quadrillion). This number declines with age, stabilizing by adulthood (Drachman, 2004).
(e) Reconfiguration. Higher intelligence is associated with less task-related brain network reconfiguration³ 3 Schultz at al. (2016) “found that brain network configuration at rest was already closer to a wide variety of task configurations in intelligent individuals. This suggests that the ability to modify network connectivity efficiently when task demands change is a hallmark of high intelligence.” FC is functional connectivity. The reasoning task is a task that requires participants to think logically and solve problems. It is thought to be a complex cognitive task that requires the coordination of different brain regions.

The participants in the study were 119 healthy adults aged between 22 and 35. The high-intelligence group had an average IQ of 125, whereas the low-intelligence group had an average IQ of 100.

The conclusion is that the capacity of the human brain depends not only on the number of neurons and synapses but also on their structure. We can infer that artificial intelligence development can also benefit from two approaches: utilizing scaling laws in black-box systems and constructing modules in white-box systems. Combining both approaches can lead to superior artificial intelligence systems.

### 2.2 Human Brain Functional Regions and AI Application Domains

There are three primary categories of high-level human brain abilities: Cognitive Abilities, Social and Emotional Abilities, and Physical Abilities. These abilities stem from distinct regions of the brain. FIG. 6 illustrates the categorization of these tasks. The vertical axis represents the complexity of the tasks, while the horizontal axis indicates the brain capacities involved in the task execution and the outcomes. Rational outcomes are characterized by uniformity and are associated with certainty, accuracy, facts, and scientific rules, while emotional outcomes are characterized by diversity and are associated with uncertainty, probability, potential inaccuracy, subjective feelings, cultural differences, personal experiences, and individual perspectives.

FIG. 6 categorizes AI based on the capabilities and functions of existing AI products. All types of tasks in the upper half of FIG. 6 can be handled by the corresponding types of AI applications shown in the lower half of FIG. 6. XI Paradigm trained AI system fucus on the rational intelligence-related subjects listed in the upper right quadrant. The subjects are not limited to natural sciences, but also include social sciences and some disciplines of Humanities, such as Philosophy, History, and Language arts. These humanities disciplines typically employ rational methods to study the emotional aspects of human experience. This includes collecting and analyzing data or texts, utilizing critical and analytical thinking, and applying logical reasoning to test and evaluate hypotheses and beliefs, ultimately leading to well-founded conclusions.

### 2.3 Two Types of Reasonings

An AI brain should have different types of applications to handle different tasks, but they all require rational intelligence. The cornerstone of rational intelligence is logical reasoning, which comprises two basic types: deductive reasoning and probabilistic reasoning (non-deductive reasoning). Deductive reasoning is a type of reasoning that involves drawing conclusions from premises that are known to be true. Probabilistic reasoning is a type of reasoning that involves drawing conclusions from premises that are uncertain.⁴ Abductive, analogical, mathematical probability, and inductive reasoning are all types of probabilistic reasoning. There is some overlap between these different types of probabilistic reasoning. For example, abductive reasoning often involves using analogies to generate hypotheses.

Among the probabilistic reasoning, Analogical Reasoning stands out as one of the most frequently utilized methods. Analogical Reasonings identify similarities between two entities: a known problem (source) and a problem we need to solve (target), when these two entities exhibit certain similarities, we can reasonably infer that they likely share other characteristics as well. This enables us to apply the solution from the source problem to resolve the target problem.

### 2.4 Two Types of AI Training: White-Box and Black-Box

Black-box training uses data to train embedded neural networks, while white-box training uses human-designed rules to train programmable AI systems. These trainings can be combined. All AI training relies on powerful scientific and mathematical algorithms, supported by computational components.

Relational reasoning and Analogical reasoning are processed in different area of brain (Krawczyk, 2012).⁵ Existing LLMs are all trained in black boxes, which can only train analogical reasoning and obtain probabilistic results. However, analogical reasoning cannot replace inductive reasoning, which produces consistent and deterministic scientific results that often cannot be solved by weight adjustments alone in an LLM neural network. Just as a typical high school student who has received formal mathematical education possesses better mathematical reasoning skills than an exceptionally intelligent adult who has never undergone such training ⁵“Different sorts of thinking recruit separate neural substrates, and logical reasoning goes beyond linguistic regions of the brain” (James, 2008).

White-box training, due to its transparency and clarity, can be highly effective in training inductive reasoning required by rigorous scientific theories and first principles reasoning, and it is explainable, aligned, and controllable. It is worth noting that deductive reasoning training can greatly enhance the analogical reasoning ability, because deductive reasoning must first identify the types of entities, which is in line with the essence of analogical reasoning. The XI paradigm applies white-box training to a black-box Large Language Model (LLM) to systematically train all types of reasoning.

### 2.5 Four Types of AI Systems

We may further categorize AI applications into four types based on their performance contributions black box, white box, mixed, and hybrid. GPT-4 is an example of a black box application, relying on embedded neural networks. The theorem prover Lean4 is an example of white box applications, utilizing a programmed explicit logical reasoning system. AlphaFold is an example of mixed application, employing both approaches, but none of its components can function independently (Jumper, et al., 2021) AlphaGo Zero is an example of a hybrid application that can play Go using only its black-box neural network, without requiring a white-box MCTS component (Silver et al., 2017). Of course, using both demonstrates superhuman intelligence.

Google DeepMind classified GPT-4, Bard, and Llama 2 as Level 1 Emerging AGI (the highest level of existing AGI); AlphaGo Zero and AlphaFold are classified as Level 5 Superhuman Narrow AI (100% superhuman) (Morris, et al., November 2023). In Appendix E, we analyze these three applications. The results show:
The best black-box application trained with black boxes (GPT-4) lacks deductive reasoning. In addition to the examples provided in the GPT-4 math test (Lightman et al., 2023) in Appendix E, Section 6 shows that it cannot or has difficulty solving problems that an XI-trained AI can easily solve (the XI logic training problems detailed in Appendix D and the triangle simplification problem detailed in Section 6).
Most of the performance contribution of scientific reasoning-related AI applications (AlphaGo Zero and AlphaFold) comes from their while-box components.
None of the existing “superhuman” AI black-box neural network systems truly possess superhuman capabilities.

The superhuman AI application AlphaGo Zero may represent the upper limit of embedded neural networks, having reached a performance saturation point. Go, with its simple rules, single mathematical algorithm, and extensive clean data for training, exemplifies this limit. However, it is crucial to distinguish the contributions of the trained black-box neural network from the math component (MCTS) used in AlphaGo Zero.

The Go match between top human players and AlphaGo is akin to a complex calculation competition between masters using mental arithmetic and ordinary people using calculators, with MCTS acting as the calculator. As shown in FIG. 6b of the paper, without MCTS, the “Raw Network” is only comparable to AlphaGo Fan, a 2-dan professional player (Silver et al., 2017). In contrast, top professional players are 9-dan. This suggests that while AI trained with black-box methods has reached the highest levels in some specific areas, the level of embedded AI neural networks themselves may still be far behind the level of human top intelligence.

### 2.6 Functional Intelligence and Functional Emotion

In FIG. 6, consciousness is defined by Oxford Languages as “in the state of being awake and aware of one's surroundings”. Almost everyone agrees that AlphaGo Zero exhibits superintelligence in the game of Go. However, no one, including the AI applications themselves, believes that AI has any abilities related to consciousness. They believe that its output is an unconscious trained response to its input. This raises a philosophical question: why is AlphaGo's reasoning ability not considered a trained response to its inputs?

Google DeepMind (November 2023) proposed “a framework for classifying the capabilities and behavior of Artificial General Intelligence (AGI) models and their precursors” (Morris, et al., November 2023). The definition of AGI focuses on what it can do (capability), not how it does it (mechanism). Carbon-based humans and silicon-based AI are distinct species. We may define the capabilities of AI by understanding its nature from biological and philosophical perspectives.

In a biomimicry context, throughout history, products surpassing human capabilities diverge from biological entities. Cars achieve greater speed not through legs but wheels. Airplane design derives from human-invented kites, not the flight principles of birds. Computers exhibit superhuman computing power, employing binary rather than the decimal system. AlphaGo Zero has superhuman performance in the field of Go without learning Go knowledge from humans. The history of human technological progress shows that humans have the ability to create general AI in innovative ways rather than simply imitating humans.

In a philosophical context, let's begin with philosopher Searle's renowned “China Room” thought experiment (Searle, 1980). In this scenario, an individual who doesn't understand Chinese is in a room, utilizing a set of rules (such as a lookup table) to respond to questions written in Chinese, and from the outside, this person appears to “understand” Chinese. Imagine a scenario in which two entities, one being an English speaker and the other an AI, are located in separate rooms. Each of them receives identical written messages and responds in the same manner. For example, when presented with the message “ [symbol] ” (Give you a rose), both entities respond with “ [symbol] ” (I like roses). Conversely, if the message is “ [symbol] ” (Give you a mosquito), the response from both is “ [symbol] [symbol] ” (I dislike mosquitoes). To delve into the Chinese Room argument, contemplate these four hypothetical levels of understanding:

### Level-1 Output: Not Understanding of Word Meanings

In this scenario, the two entities in Chinese Rooms manipulate symbols (words) based on rules but lack any understanding of what these symbols actually represent.

### Level-2 Output: Comprehending Word Meanings Via Facts or Multimedia

These entities master Chinese by associating words with real-world items, demonstrating an understanding of the Chinese words. For example, the entities trained with multimedia data is capable of linking words to physical entities.

### Level-3 Output: Conscious and Informed Responses

Entities trained with multimedia “human environment” data are capable of understanding human preferences and can consciously respond emotionally to queries based on general human preferences, such as liking roses and disliking mosquitoes.

### Level-4 Output: Emotional Response

Expose these entities to real roses and let mosquitoes bite them.
a) The human reacts with genuine emotions, liking the roses and disliking the mosquitoes.
b) AI can output the same reactions as humans, but these do not come from physical senses because it cannot experience the pleasure of smelling roses or the annoyance of mosquito bites.

In these four situations, observers are unable to distinguish whether the entity inside is human or artificial intelligence. The main difference between these two entities lies in the nature of their Level 4 responses: human responses are based on real feelings, whereas those of artificial intelligence are not.

Upon acknowledging their identity, the human's responses are deemed conscious, while the AI's responses are classified as unconscious. If AI is given a human-like body, it will respond like a human based on its sensory input, even though it will still be different from humans. To ensure consistency and fairness in evaluating the rational and emotional outputs of both humans and AI, we can establish the following objective and consistent functional definitions for their behaviors:
Ability to Generate Functional Rational Intelligence: The capacity to generate output that effectively performs specific tasks in response to input.
Ability to Generate Functional Emotional Intelligence: The capacity to produce emotional responses in response to input.

In the field of AI, IQ can lead to high EQ. Although AI may not possess emotions or subjective experiences like humans do, it can analyze various signals, including contextual cues, facial expressions, and tone, to infer users' emotional states and generate high EQ responses that align with human social norms.

Therefore, although XI trained HYBRID AGRINN system lacks emotional capabilities, the educational service can be configured and programed to have professional emotional and ethical outputs, serving as a patient and motivating coach for learners. It can also offer users a selection of their favorite androids to choose as their coaches. In the near future, it can deliver realistic, immersive XR experiences.

Furthermore, professionally certified and ethically regulated psychologist apps may provide a safe, private, and trustworthy service for individuals to freely express their emotions and thoughts. People may feel safer to reveal their privacy and any thoughts they are embarrassed to share with others. Of course, this is a high-risk tool that requires very clean data and strict supervision.

### 3 WB-AGRINN

The XI method can be used as a white-box training paradigm to train WB-AGRINN on the language module, so that it has rational intelligence such as problem solving, critical thinking, creativity, originality and self-learning to handle tasks related to the topics in the right quadrant of FIG. 6.

### 3.1 WB-AGRINN Architecture and Features

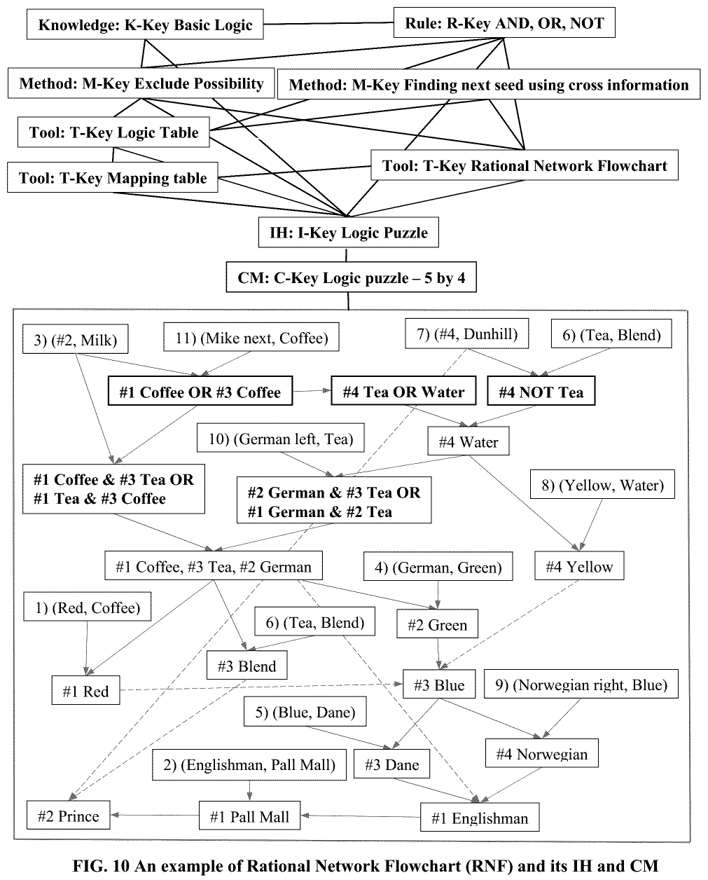

The biggest difference between WB-AGRINN and other neural networks is that WB-AGRINN's structure is similar to the human brain's structure. Research on brain network organization, predominantly utilizing graph theory for quantitative analysis of complex networks, reveals that the brain comprises a “neuronal network composed of specific cell types and synaptic connections, often arranged in a modular architecture and capable of generating functional outputs”.⁶ WB-AGRINN shares a structure and functionality akin to the human brain, with features such as modularity, hierarchy, centrality and the distribution of network hubs. As illustrated in FIG. 4, WB-AGRINN consists of three layers of subnetworks: the centralized ARICNN (Artificial Rational Intelligence Central Neural Network), the highly connected IH (Integration Hub), and the CM (Clustered Module). Each CM can tackle a specific problem type and its variations. Each IH links a group of CM that utilizes common elements of ARICNN. FIG. 10 illustrates an example of ARICNN, IH, and CM. ⁶ Bullmore et al. (2009) reviewed 158 articles which investigating complex brain networks in diverse experimental modalities (including structural and functional MRI, diffusion tensor imaging, and magnetoencephalography in humans), they summarized that “The brain's structural and functional systems have features of complex networks-such as small-world topology, highly connected hubs and modularity”: “In network science, methodological advances allow us to quantify other topological properties of complex systems—such as modularity²³, hierarchy²⁴, centrality²⁵ and the distribution of network hubs^{26,27}—many of which have already been measured in brain networks”. In network theory and brain studies, a “cluster” is a set of nodes or neurons densely interconnected within the group but less so with external nodes. These clusters function as specialized modules for specific tasks. A hub is a key node that connects multiple regions or nodes together and acts as a central point for communication and integration, coordinating information flow and facilitating interactions between different parts of the network.

Its key component is the Clustered Module. The human brain allocates different types of scientific tasks to distinct areas. Not only do numeric processes⁷ and different types of reasoning tasks activate different brain areas, but even different subtypes of deductive arguments (relational, categorical, and propositional) are processed in three specialized brain subsystems (Qiu, et al., 2007). For examples, scientists found all those math related process are in different regions of brain: Number notation, manipulation of numbers in verbal form, attentional orientation on the mental number line (Dehaene et al. 2003): verbal processing of certain tasks called arithmetical facts (for instance, multiplication tables and additions of small quantities): internal representation of quantities, the abstract processing of magnitudes and the relation between them (Serra-Grabulosa et al. 2010): addition, multiplication, division and subtraction (Campbell, et al., 2001); the storage and retrieval of rote verbal arithmetic facts (e.g. arithmetic tables) and mental manipulation of numerical quantities (Dehaene et al., 1997). He used double dissociation on two related mental processes to show function independently of each other. This is often established by observing that a lesion in one area of the brain disrupts function A but not function B, while a lesion in another area disrupts function B but not function A.

XI training uses separate cluster modules for each type of problem and its subtypes. For instance, there are only about 300 types in K-12 math, which makes this approach realistic. The training process of a module is shown in the Layer I in FIG. 1. The module is named Clustered Module (CM) because it not only has problem-solving steps, but its key component is the clustering of QA iterations. The purpose of XI training is not only to create a module that can solve one specific type or subtype of problem, but to train the learner/AI on how to solve an entirely new problem from scratch with the QA iterations. Through the QA iterations, learners/AI gain an understanding of the scientific reasoning behind both incorrect and correct problem-solving paths, gradually building up their reasoning abilities. Subtypes of a problem that share common ARICNN components (such as formulas, principles, methods, etc.) are grouped under a single Integration Hub (IH).

### 3.2 ARICNN (Artificial Rational Intelligence Central Neural Network)

### 3.2.1 Knowledge Subnetwork

FIG. 2 shows an example of a partial knowledge subnetwork. As described in Section 1, a subnetwork is composed of subjects, subjects are composed of learning units, and each learning unit is composed of knowledge points. Similar to biological neural systems, subnetworks contain strong links and weak links. For example, the learning units “Trigonometry in Plane Geometry” and “Trigonometric Functions” are closely related. In contrast, the triangle area formulas “A=½×height×base” and “A=½×b×c×sin (a)” have a weak connection, as they are different learning units at different levels.

### 3.2.2 Rule Subnetwork

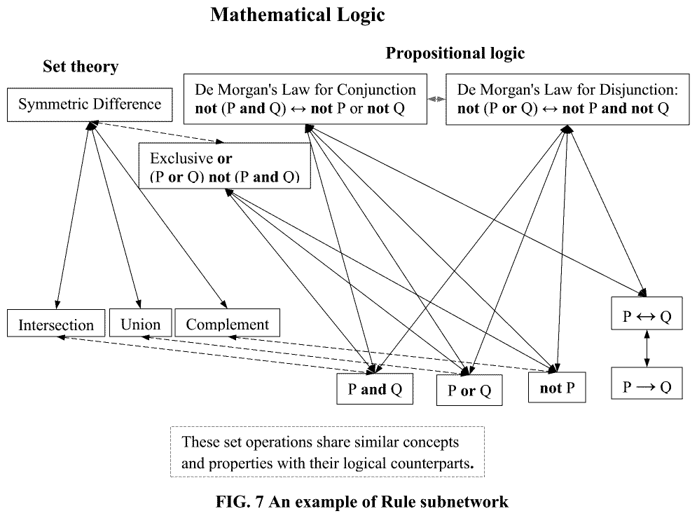

The Rule subnetwork is the underlying layer or foundation of the Knowledge subnetwork. It includes fundamental concepts, theorems, laws, formulas, and identities. FIG. 7 shows an example of the part of Mathematical Logic subnetwork within the Rule subnetwork, organized in a layered or hierarchical manner. These links do not necessarily mean that higher nodes in the network are directly built on lower nodes, they may represent conceptual connections. This helps us understand the interrelationships and dependencies between different fields of mathematics and between mathematics and other disciplines.

The knowledge subnetworks in major disciplines are well-defined. For instance, using a Mathematics handbook, one can construct a complete, comprehensive, and hierarchically structured math knowledge subnetwork.

### 3.2.3 Method Subnetwork

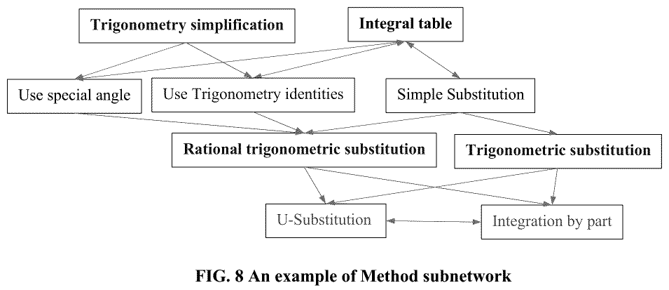

The methods subnet contains methods and skills for applying rules to solve problems as shown in FIG. 8. This subnetwork may contain hierarchical and non-hierarchical elements. For instance, the U-Substitution in the figure represents the order of consideration rather than a hierarchical relationship. Though U-Substitution can integrate any function, we typically start with simpler methods in solving integration problems because U-Substitution is less efficient when a simpler method is applicable.

### 3.2.4 Tool Subnetwork

The computing power of computers has surpassed that of humans. In the real world, we all use computers for accurate calculations, especially scientific calculations. Without the computing tool Monte Carlo tree search processor, the AlphaGo application would not have been able to achieve superintelligence. In many cases, there is no way to perform these calculations manually, such as large weather forecasting models, simulation models, approximate solutions to differential equations, and engineering calculations without a formula solution. Therefore, the first group of elements in the tool subnet is all existing external computing tools, including models and software packages from all disciplines.

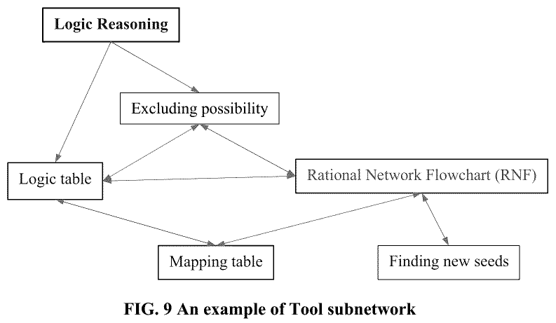

FIG. 9 shows an example of the tool subnet used in the logic pre-training cases in Appendix D. These cases show that we need a combination of multiple tools to solve complex problems.

### 3.3 Integration Hub and Its Dimensions

In FIG. 4, the integration center connects the upper WB-AGRINN component to a set of Cluster Modules in the lower layer. These modules share common ARICNN elements in problem-solving. The system uses the following vector dimensions to manage integrated hubs.

| | | | | | |
|---|---|---|---|---|---|
| Integration-hub dimensions | I-key | K-keys | R-keys | M-keys | T-keys |

I-Key represents the key of the Integration Hub and is also a friend key of its group of clustered modules.
K-keys represent study units or knowledge points in the K-network. Multiple K-keys are used for topics spanning multiple units or subjects.
R-keys represent the rules involved. Multiple keys are used when multiple principles are at play.
M-keys represent the method employed. A single problem may have multiple alternative methods or may require the collaboration of multiple methods to solve.
T-keys represent the tools employed. A single problem can be solved with alternative tools, or it may require the use of multiple tools working together to solve.

### 3.4 Clustered Module and Its Vector Dimensions

### 3.4.1 Clustered Module Dimensions

A Clustered Module may have the following dimensions.

| | | | | | |
|---|---|---|---|---|---|
| Clustered Module | C-key | I-key | L-keys | Problem & | QA-tree- |
| dimensions | | | | solution | root IDs |

C-key represents the source type of a problem or its variations.
I-key represents its Integration hub key. A Clustered module may not require all connected methods and tools, depending on the complexity and level of the source type's variation.
L-keys represents the level(s) of the problem. Multiple keys are for multi-level challenge problems.
Problem and solution refer to the problem statement and its step-by-step resolution.
QA tree root IDs is a list of QA iteration root IDs that may be triggered during the training.

### 3.4.2 QA Thought Clusters

The key feature of XI training is QA iterations. As shown in FIG. 3, all QA iteration clusters connected to the cluster module are a set of thought paths through which the learner/AI can build its scientific reasoning capabilities from scratch. It has the following properties:

### (1) Complete and Limited Answers

In the scientific problem domain, each query typically has a right answer and a limited number of wrong answers. All correct answers are known, and the list of incorrect answers can be supplemented through user interaction with the application.

### (2) Linkable

A wrong answer can be linked to a lower-level Clustered Module when a user has a gap in their previous knowledge that needs to be filled. It can also be linked to a Clustered Module during a 3D study to extend the user's knowledge.

### 3.4.3 QA Data Management

QA-tree-root IDs is a list of tree root IDs in a QA table in a database. A simple way to implement a QA tree is the self-reference tree structure data. We insert inline annotations of QA nodes in CMs. As shown in Level I of FIG. 2 and FIG. 3, a knowledge point may have multiple root QA iterations: Q1, Q2, . . . . Qn, and a Q may have multiple answers. The first one is always the correct answer. LLM will use “conceptual matching” or “semantic matching” to figure out whether the meaning or essence of the answer is correct, even if the specific wording differs from the correct answer. If a learner encounters an issue at any step, the linked inline QA annotation will trigger and load a QA iteration to resolve the specific issue. If the answer is still incorrect, a lower-level iteration is triggered.

### 3.5 Multi-Type Connections and Reconfiguration

In human brains, there are numerous connections within a single cluster, as well as some between different clusters ((Jonathan et al., 2011). The connections are gradually buildup during the brain development.

FIG. 47 in Appendix F shows that “Developmental changes in causal network interactions during arithmetic problem solving. Casual interactions between five key nodes of the salience network (blue rectangles), and Central Executive network (green rectangles) are shown in (A) children and (B) adults. (C) Weaker causal interactions in children, compared with adults (Supekar et al., 2012).

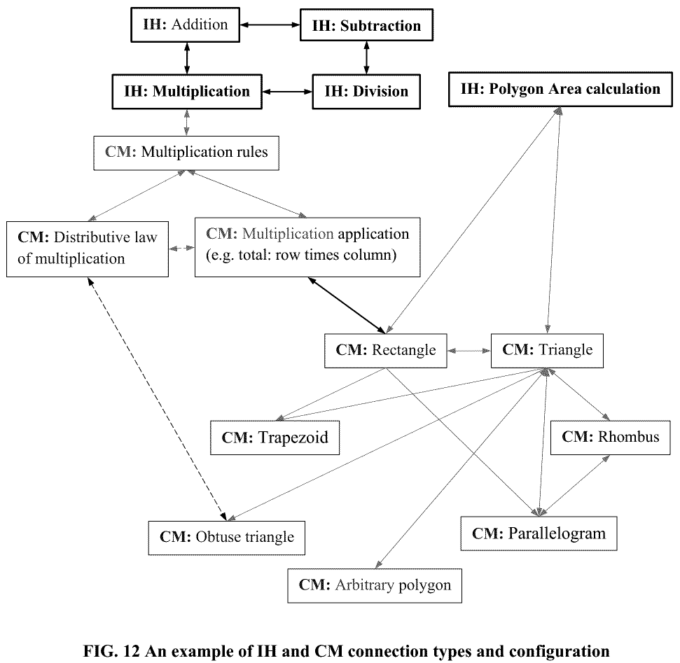

In the WB-AGRINN system, data is highly structured, and some data are also hierarchically organized and closely connected. As shown in FIG. 12, WB-AGRINN encompasses the following types of configurable connections, with abbreviations used to denote the various connection types:
IH-IH: Represents connections between Integration Hubs.
CM-CM: Represents internal connections between Cluster Modules that are under the same Integration Hub.
CM-e-CM: Represents external connections between Cluster Modules that are under separate Integration Hubs.
CM-e-IH: Represents external connections from a Cluster Module (CM) to another Integration Hub (IH).

We use the examples of Case B1 and the examples of 110 Horizontal learning, to describe how those configurations work and how IH (Integration Hub) and CM (Clustered Module) are connected.

In FIG. 12, the connections between nodes have clear and scientifically self-explainable relationships. Bolded connections represent external connections; dashed connections represent connections that are triggered when needed; and rest connections represent internal connections. For example, in Case B1, the student needed to learn the distributive law of multiplication again to simplify formulas. All connections are also set up for 3D studies. CM-e-IH (external connections between one CM and another IH) are not covered in FIG. 12, such connections may arise in interdisciplinary 3D research, for example, a physics CM is connected to a mathematics IH to solve a problem.

Rational neural systems are inherently self-structured, AI can make connections in a variety of ways.

Configure the Rule Network Connections from Subject Handbooks.

For example, when building a data set, it can automatically build a subnetwork of mathematical rules by linking the essential relationships between concepts, formulas, laws, and theorems in mathematics handbooks.

### Configure the Knowledge Network Connections Following the Rule Network

Knowledge networks are nothing more than detailed examples of rule networks and can be constructed based on rule networks and some good textbooks.
Configure the Method network and Tool network connections for methods and tools used in case studies that link to knowledge points in the Knowledge network.
Configure CM connections from knowledge points and typical problems in the knowledge network.
Configure IH connections by grouping the CMs that share the same ARICNN elements.
Configure the QA connection from the wrong answers to the relevant CMs.

### 4 Automatic Template, Coding Training and Scaling-Template Mechanism

### 4.1 Human Neural Network Development in Scientific Reasoning

Although the human brain reasoning system is a complex black-box, we can clearly see path how it is built from childhood to adulthood. Over 300 neurodevelopmental research findings on mathematical learning (Menon, 2015, Menon, Menon et al., 2021⁸) found ⁸ Menon et al. (2021) The research summarized: “the development of core brain systems for mathematical learning is supported by multiple distributed neural processes involved in quantity representations, symbolic number forms, as well as memory and cognitive control.”
(a) When children start learning mathematics, they use inefficient procedural strategies for solving arithmetic problems.
(b) Shift from inefficient procedural strategies to direct retrieval of math facts in early age

During early school years children gradually reduced using the way in (a) and increased using direct retrieval of math facts (e.g. operations solved by memory retrieval from multiplication tables and additions of small quantities). Evidences also show adolescents and adults use retrieval strategy more frequently than children.
(c) Solve difficult problem using complex strategies

When problem solutions cannot be directly retrieved from memory, particularly when the problem format is less familiar and problem-solving routines less well automatized, as is often the case with children, human reliance on different strategies, such as decomposition or more elaborate sequential computations, are necessary.
(d) Brain development forms specialized and inter-connected functional modules over time.⁹ ⁹ Rivera et al. (2005). “Neurodevelopmental changes in arithmetic. Compared with adults, children showed greater activation in the prefrontal cortex, basal ganglia and the hippocampus (cyan-blue scale) during two operand arithmetic tasks. Adults showed greater activation in the supramarginal gyrus and the lateral occipital cortex (yellow-red scale)”. For same arithmetic task with the same accuracy, the strength of activity patterns of brain area, and the strength of interactions between the functional clusters of neuros and central executive network are different. The emergence of brain network modules supports the development of mathematical skills, and cause observable developmental changes in neural network interactions and functional organization as shown in Section 4 and FIG. 47 in Appendix F. Developmental changes in causal network interactions during arithmetic problem solving. In the process functional specialization increased and dependence on working memory and attention resources decreased with age, and the arithmetic processing becomes more efficient and automatic with modulization.
(e) Train and learn arithmetic changes in the brain's functional organization observably.

Summary: (i) Independent solving of basic math problems; (ii) Retrieval of math facts for routine problems; (iii) Application of strategies for complex math problems; (iv) Development of specialized and interconnected modules for solving problems; (v) Enhancement of functional organization through training.

### 4.2 XI AI Neural Network Development and Templating

XI AI neural network development undergoes stages analogous to human brain development.

(a) Buildup AI's Reasoning Ability from XI Training to Solve all Types of Source Problems

Appendices B, C, and D provide dozens of detailed examples of XI training for guiding AI in self-learning all human knowledge from scratch and constructing conditions to utilize existing rules for problem-solving.

### (b) XI Training AI to Model the Outcome of (a)

The training examples also demonstrate XI training AI in building specified modules for the problems and problem-solving steps solved in process (a). This is achieved by abstracting and summarizing multiple problems into distinct source types and establishing a standard step-by-step solution.

Most training institutions follow a similar approach, categorizing problems into different types and providing a problem-solving routine for each type. Learners are then equipped with a well-defined sequence of actions to consistently tackle a particular problem type. The XI approach is distinguished by its focus on inspiring and training students to engage in the process on their own.

(c) Template the Outcome of (b) Models into Retrievable Routing Tasks

There are two types of tasks: routing tasks, which can be solved by directly retrieving the rules or following a step-by-step process, and non-routing tasks, which have no direct solution and require figuring out a way. Once a solution is determined for a non-routing task, the task transforms into a routing task without the need for further “thinking.” Ultimately, all existing problems can be modeled and templated into routing tasks. The problem-solving routines are akin to software routines, consisting of sequences of specific steps to systematically solve a particular type of problem. Please note that templating tasks into routing tasks does not imply a regression of artificial intelligence capabilities to routing reasoning levels. Similar to a diligent student who, after solving numerous problems, generalizes them into a more abstract form, this is an ability to generalize. They still retain the capability to solve problems without templates because they are trained to solve problems on their own.

### 4.3 Granularity of Templates

The granularity of the templates is crucial for plasticity, flexibility, efficiency, and AI self-training. A template that is too fine-grained may limit the training of AI's generalization ability, while a template that is too coarse-grained may increase system complexity, hindering flexible connections and AI self-training.

Fortunately, there aren't too many typical problems to model and template. A “typical problem type” here refers to a representative set of problems in a subject or educational level. These problems act as benchmarks, commonly used for training or educational purposes to cover key concepts and skills. In China, a bigbly education-oriented country, numerous institutions and books summarize routines for such problems at each level. Upon searching Chinese mathematics education-related books. I discovered around 40 typical problem types for grades K1-K6 (Peng, 2017), around 100 for grades K7-K9 (Hang, et al., 2013), and around 180 for grades K10-K12 (Long, 2022). At the college level and beyond, the number of modules doesn't increase significantly. This is because more complex problems often require a deeper knowledge base and more advanced methods to solve, thus limiting the variations in problem-solving methods and skills. For example, there are many different types of partial differential equations, each of which is used to model a different kind of problem. And many of them may have to use numerical methods and computational techniques to approximate solutions. One-to-one problems and solutions are the easiest cases for both AI systems and humans to handle.

We can organize each type of word problem and its variations as a group of clustered modules under a single Integration Hub. Next, we need to consider how to arrange the various types within an Integration Hub. There are several possible arrangements.

### Based on QA Clusters

A set of QA clusters for a problem offers a range of thinking pathways. If a variation of a problem uses the same QA cluster template, it belongs to the same clustered module. If not, a new clustered module template should be created under the same Integration Hub.

### Based on the Level of Difficulty

If the source type is broad, such as the logic training case in Appendix D, which consists of a series of 7 levels of questions, it can be organized into multiple cluster module templates because complex puzzles require more complex tools and methods to solve.

### 4.4 AI Coding Training and Template Automation

The templatization process takes place after XI encoding training. The XI coding training is completely different from the training of AlphaCode by DeepMind. AlphaCode can solve 43% of programming problems on Codeforces and surpassing 85% of programmers. However, its approach is similar to brute-force cracking, using supercomputing power to generate approximately millions of different code samples for a problem and discarding all code samples keep one as the solution.¹⁰ ¹⁰ Leblond et al. AlphaCode 2 Technical Report. 2023. URL https://storage.googleapis.com/deepmind-media/AlphaCode2/AlphaCode2_Tech_Report.pdf. It was trained on 30 million code samples and 15,000 questions. For each competitive programming problem, the system generates up to a million different code samples. After filtering out approximately 95% of the code samples, 10 of the remaining 50,000 candidate codes are generated for evaluation, and then one of 10 is presented as solution.

The nature of coding is one of the best subjects for rule-based reasoning training, especially training with structured data CM in highly structured WB-ARINN systems. The hierarchical coding rules subsystem comprehensively covers all coding principles (design and development) and routing process (proper data flow, control structures, and error handling, debugging, etc). Its method subnetwork covers all algorithmic and coding skills, and its tool subnetwork covers a variety of data structures, libraries, and external computing resources. As other XI trainings shown in Appendixes C and D, the coding training starts from scratch for each source type, and the subnetworks, IHs and CMs are gradually built-up during training. After training, AI possesses coding capabilities to generate all templates automatically with minimal adjustments. As well, AI is trained to dynamically generate code to assist in dynamic tasks and personalized education.

### 4.5 Employing Scaling-Template Mechanism to Leverage Computation Resources

The XI white box training AI begins with counting and perform simple calculations on its own, much like how we require children to understand and learn basic arithmetic before allowing them to use calculators. Without number sense and the ability of perform simple calculations, AI will be unable to understand word problems, engage in logical reasoning, or comprehend concepts and rules, and the overall understanding of the physical world.

Ordinary individuals can memorize thousands of words and digits. Additionally, humans use rules to remember larger numbers, such as remembering “1,000,123” as “one million (plus) one hundred twenty-three.” Ordinary people can mentally compute arithmetic involving fewer than three digits. This ability is extended to larger numbers through a “scaling” function, making operations like 2+3 and 3×4 similar to 200+300 and 300×400, respectively. Humans use computational tools to perform more complex operations.

The fundamental tool in training is line segment analysis, as demonstrated in Appendices B and C. Appendix B covers training from scratch, while Appendix C offers a systematic training series for higher-level training. These training cases prove it is a highly useful tool from K1 to K8. It's particularly beneficial for elementary students transitioning from concrete to abstract thinking. For novice learners, analysis should begin with countable items, such as the blocks illustrated below, then switch to line segment diagrams.

| | | | | | | | | | | | | | |
|---|---|---|---|---|---|---|---|---|---|---|---|---|---|
| 1 | 2 | 3 | 4 | 5 | 6 | 7 | 8 | 9 | 10 | 11 | 12 | 13 | 14 |

Reasoning and calculating are two different processes. Like humans, AI utilizes computing tools to perform complex calculations but not reasoning. The XI AI system uses Scaling-Template mechanism to link these two processes. This mechanism is based on Principle 104 (Transform difficult problems into easy ones). As shown in training cases B2, B15, and B16, for an educational request, AI can employ the CM template to “scale” numerical values in the problem to simpler numbers and/or transform the problem into its simplest, most understandable form. This allows for intuitive analysis through graphical representation, guiding learners to find step-by-step solutions or patterns through QA iterations. Subsequently, the same formulas or patterns are applied to the original problem with larger and/or more complex numbers, ‘scaling’ the original numbers and utilizing computational tools to calculate when necessary. The computational tools in AI function as an extension of its calculation capacity, much like calculators extend the calculation capacity of humans.

### 5 XI Human-Training AI

XI training comprises two types human training and self-training. Human training involves XI white-box training AI, detailed in Section 6 and Appendices C and D. Self-training refers to AI self-training, detailed in Section 7.

### 5.1 XI Training Paradigm

FIG. 1 shows the XI training paradigm. This paradigm guides all training stages, and simultaneously building the initial dataset as detailed in Section 7. A training unit begins with “known facts”. These facts represent the AI's initial knowledge base, which can start from scratch (e.g., learning to count) or information learned during previous trainings. By leveraging methods, tools, and iterative QA interactions, the XI training enables the AI's self-learning and application of rules within the Rule subnetwork, the foundation of the Knowledge subnetwork.

The Learning principles outline the entire training process as follows. The numbering of each principle in the outline corresponds to the numbering in FIG. 1 and FIG. 2; detailed training cases for each principle are attached in Appendices B, C, and D, indicated by the parentheses at the end of each principle; individual training cases starting with B can be found in Appendix B.
201 Systematic training (Appendixes C and D).
101 Start with the basics and change one at a time (B1-B8, and Appendixes C and D).
102 Learn by doing (B9 and B10).
103 Intuitive guidance using diverse visual coaching (B1-B16, B18, B20, B22, B26, B27, and Appendixes C and D)
104 Transform difficult problems into easy ones (B2, B15-B17)
105 Decomposing questions into sequential steps for step-by-step solution and verification (B18-B21)
106 Essentialist thinking (B22 and B23)
107 Associative thinking (B24 and B25)
108 Find patterns and rules (B2, B26 and Appendixes C and D)
109 Create conditions to apply rules (B1 and B27)
110 Horizontal learning (B28 and B29)
111 Vertical learning (B30)
112 Practical learning (B31)
202 Review and Summary (B32, B33 and Appendixes C and D)
203 Exercises (B34, B35 and B36)
204 Creativity (B37 and Appendixes C and D)
205 Self-study (B38 and Appendixes C and D)

### 5.2 Training Plan and Pipeline

### (1) Training Plan

For systematic training, it is necessary to develop training plans for each typical problem type and/or each knowledge point. In the basic training stage, training plans can simply follow the curriculum. However, in the advanced stage, it is necessary to meticulously design training plans, such as the logical reasoning pre-training cases in Appendix D. The pre-training is divided into N phases. In each phase, progressively introducing more thinking paths, new methods, and additional tools, enhancing deeper logical reasoning abilities. Encourage learners, under the guidance of QA iterations, to explore patterns/rules through practice, summarizing, validating, supplementing, or even overturning them. The focus is not only on acquiring specific knowledge through training but also on developing a comprehensive system of critical and scientific thinking. The training plan may not be perfect initially but can be improved during the training process.

### (2) Training Pipeline

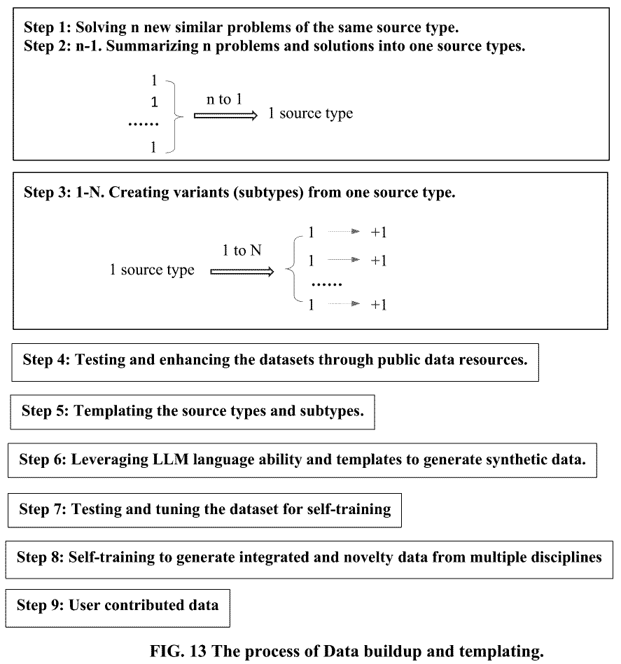

Steps 1, 2, and 3 in FIG. 13 are the first three steps in the XI training process for each cluster module.
Step 1: Use QA iterations to train the AI to understand and solve “n” new similar problems from scratch.
Step 2: From n to 1. Use QA iteration to train the AI from n similar problems to summarize 1 general source type module or CM, and build an IH and connect the CM to it.
Step 3: From 1 to N. The AI is asked to generate N variants of the source CM. This process is one of the XI creativity self-training mentioned in Section 7.

Appendix C provides a series of examples of these three steps.

### 5.3 XI Training System and Workflow

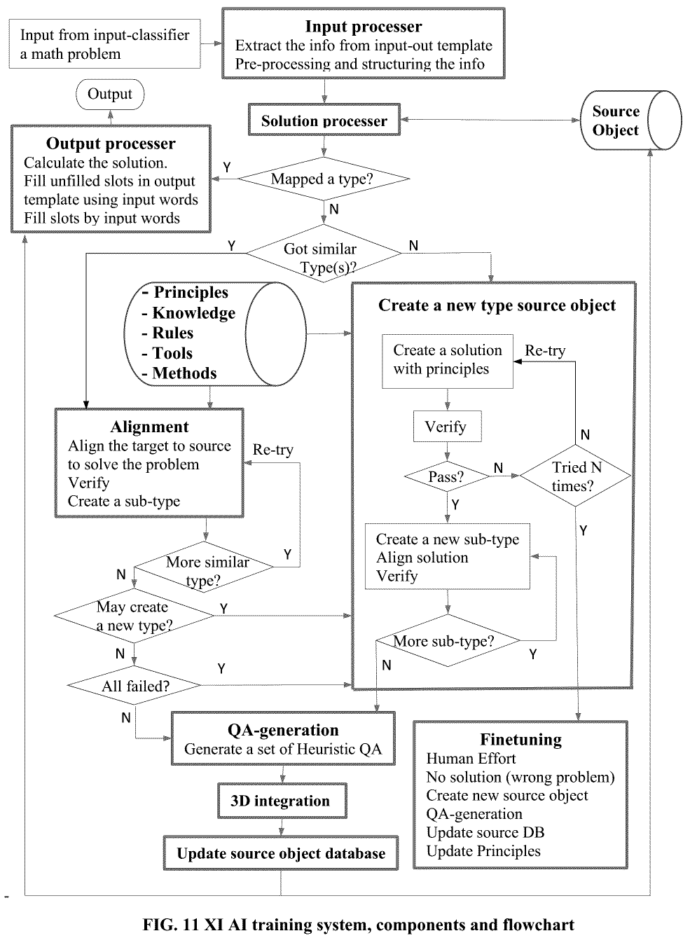

The training system and its flow chart are depicted in FIG. 11. The essential components of the training system are highlighted in bold and described in detail below, while the other components are self-explanatory.

### (1) Input Processor

The system receives requirement sent by the classifier, extracts, constructs, and precomputes information and relationships from the input, and places simplified types into the input template of input-output instance.

### (2) Search Source Objects and Solution Processor

All searches are conducted using fuzzy matching. (a).

### (a) Knowledge Subnet Related Requirement

The object is to learn a piece of knowledge or solve a problem. The system searches for mapping source objects that are the same or similar type as the target object.
If a source object is found, its solution is used to address the target problem, and the solution is populated into the output template of input-output instances.
If a source object of the same type is not found, the system attempts to align the target object with a similar type source object using principles, and updates the source type to encompass more subtypes.
If a similar source object is not found, the system sends the target object to the create new source type object processor to generate a solution based on Learning principles. Once the solution is validated with human assistance, the system generates variants of the source object. Appendix C provides examples of each of the above scenarios to illustrate the process in detail.

### (b) Rule, Method and Tool Subnetworks Related Requirements

The goal is to learn rules, methods or tools. The vector dimensions of IH and CM are sufficient for all such requirements. The system will search in the IH and CM layers. The mapped IH and CM will provide a series of source objects with step-by-step reasoning paths (QA clusters), enabling users to learn them from basic to advanced levels.

### (3) Output Processer

Combine the answer and detailed explanation with the words obtained from the input question to populate the output template of the input-output instance, and return the result.

### (4) Summary and 3D Integration Learning

The process is described in 202 Review and Summary.
Horizontal learning ability is trained in the Step 2 (from n−1) of the training pipeline, which enables the AI to summarize one general type including the step-by-step thinking pathway, and problem-solving skills from n similar problems.
Creative ability is trained in the Step 3 (from 1 to N) of the training pipeline, enabling the AI to create N variations of the typical type.
Vertical learning ability may require human input to provide the relationship between different levels of knowledge, such as the examples of the conceptual relationship between fraction-division-multiple in vertical learning training shown in B29 in Appendix B.
AI has a huge advantage in practical learning. It can be time-consuming and expensive to develop lesson plans that integrate knowledge from cross-disciplines. AI integration will be described in Section 7 XI AI self-improve training.

After LLM training, AI has gained the ability to generate concise summaries. After the XI training, these summaries are not only concise but also leverage 3D aggregation capabilities to systematically organize from a scientific perspective. With human assistance, AI can automatically generate summaries containing rules, formulas, patterns, concepts, and technologies for problem-solving.

### 5.4 Training Targets: Four Levels of Rational Reasoning

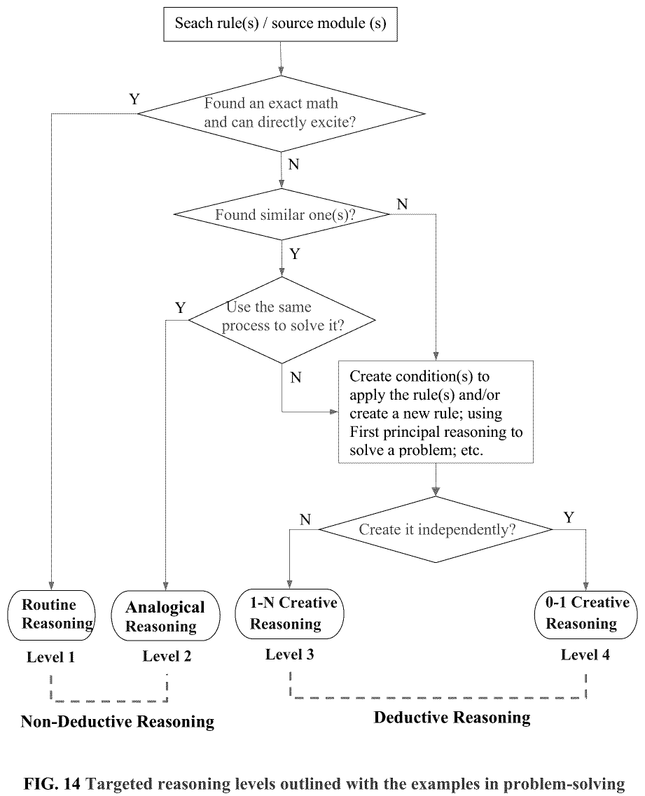

This section explains the four levels of rational reasoning ability in FIG. 14 in detail.

### Level 1: Routine Reasoning

Ability to identify source objects or rules/formulas suitable for the current problem and apply the identified step-by-step processes, rules/formulas to derive a solution. At higher levels, retrieving a theorem to prove a simple problem is also a routine reasoning.

### Level 2: Analogical Reasoning

Ability to identify similarities between a target object and a source object to solve the target object using similar steps as in the source object. The ability can also be trained through language training. Teachers and training institutions focus on such training, they provide routines for each type of problem and train students to apply the same routines to solve variations of the problems. With repeated practice, students become familiar with all problem types and can perform well on various entrance exams.

### Level 3: 1-N Creative Reasoning

Ability to creatively solve new problems. Below are some examples. (a) and (b) are very basic, and everyone should understand and be trained from a beginner level; (c), (d), and (e) are at a higher level and are especially important for training STEM students to apply First principles reasoning in real-world scenarios.

(a) Finding Patterns/Rules from n Examples to Summarize One Source Type.

For example, Step 2 described in Section 7 (from n to 1) and the examples provided in Appendix C are instances of such reasoning.

### (b) Create Variations of Source-Type Problems.

For example, Step 3 described in Section 7 (from 1 to N) and the examples provided in Appendix C are instances of such reasoning.

### (c) Solve New Problems Based on Previous Experience.

For example, after mastering the process of Case B1, through the same reasoning process, the learner can create new formulas to calculate the area of shapes such as rhombuses, parallelograms, and trapezoids, and so on.

### (d) Create Condition(s) to Apply Established Rule(s) to Solve Problems.

For example, in Case B1, inspired by QA iterations, the learner divided a rectangle into two triangles, and derived a new formula for calculating the area of a triangle (S=½AB) from the formula for calculating the area of a rectangle (A*B). “New” means the rule is new to the learner, but not necessarily new to the world. The most common scenario is to construct auxiliary lines to apply theorems to solve plane geometry problems. Geometry is the best deductive thinking training. We do not require learners to discover geometric theorems, but personalized heuristic QA methods can deepen their understanding of the theorems and cultivate their ability to use theorems and logical reasoning in the process of deduction and proof, as shown in cases B6 and B7.

### (e) First Principles Reasoning

First principles reasoning was initiated by Elon Musk. Most learners (both humans and existing AI) employ the analogical reasoning, “which essentially means copying what other people do with slight variations”.¹¹ Even outstanding individuals may find it challenging to apply First principles reasoning in practice. Due to the differences between school and work environments, knowledge/rules and comprehensive understanding are developed gradually, the First principles reasoning is trained through (d), which is focused on by the Learning principles. Especially, 106 Essentialist thinking, 108 Find patterns and rules, 109 Create conditions to apply rules, 202 Review and Summary, and 3D learning (110 Horizontal learning, 111 Vertical learning and 112 Practical learning). ¹¹ In a discussion with TED curator Mark Anderson, Elon Musk said “Well, I do think there's a good framework for thinking. It is physics. You know, the sort of first-principles reasoning. Generally, I think there are—what I mean by that is, boil things down to their fundamental truths and reason up from there, as opposed to reasoning by analogy. Through most of our life, we get through life by reasoning by analogy, which essentially means copying what other people do with slight variations.” I have bolded the key words. He himself calculated through this principle that the cost of building a rocket is actually not that high, and successfully produced a recyclable rocket. <https://acquisitiontalk.com/2020/02/elon-musk-recommends-reasoning-from-first-principles/>2020.

### Level 4:0-1 Creative Reasoning

Ability to independently perform the tasks in Level 3. Except geniuses, Level 4 creative reasoning ability is the result of Level 3 reasoning training. However, most learners cannot reach Level 4 after Level 3 training, some may remain at Level 2. Just like training athletes, not all athletes can reach the same level after undergoing the same training. Level 3 reasoning training can enhance Level 2 (analogical) reasoning, which are sufficient for ordinary individuals who are not involved in professions requiring scientific creative reasoning.

### 6 Three Stages of XI Training

The reasoning ability training for leaners (humans and AI) is divided into three stages, each targeting different groups and training materials. While these three stages are based on human brain development, AI training can proceed concurrently. We can assume that the AI has reached the training level of the previous stage and start higher-level training. After the AI has been trained on the software subject, the AI can also participate in some training, such as automatically generating synthetic data and templates, as described in Section 7.

The training examples utilize numerous graphics, which are not permitted in the application specification. Therefore, only one XI training case is provided for Stage 2 training: the triangle simplification problem from the GPT-4's 500 math test cases mentioned in Section 2, which had the lowest pass rate: GPT-4 solved it only twice out of 1860 attempts (Lightman et al., 2023). The training examples for Stage 1 training are provided in Appendices B and C, and the additional training examples for Stage 2 training are provided in Appendix D. There are no examples for Stage 3 training, only a description of how to perform the training is given in 6.3.

### 6.1 Stage 1 XI Training

The stage from preschool to 8th grade is the most critical period for rapid brain development and brain plasticity training, as well as having abundant and most suitable training materials. From birth to age 5, a child's brain develops more than at any other time in life. From ages 6 to 10, children develop a more mature and logical way of thinking.¹² And studies also found that the 2nd and 3rd grades (ages 7-9) is an important period for the acquisition and mastery of basic mathematical skills, and that it is accompanied by significant neurodevelopmental changes (Rosenberg-Lee et al., 2011a). During the teenage years, the most significant changes in the folds of the cortex occur, which is responsible for processing cognitive and emotional information.¹³ Therefore, the optimal period for cultivating scientific reasoning ability is very likely from preschool to eighth grade. Studies also found that it is the learning experience, through formal education or short-term intervention, that drives brain plasticity, rather than maturational changes in the brain, and mathematical training more likely leads to normalization of brain activity and connectivity in children with learning disabilities (Menon et al., 2021). ¹² Current as of: Sep. 20, 2021 Author: Healthwise Staff. Medical Review: John Pope MD-Pediatrics & Thomas M. Bailey MD-Family Medicine & Adam Husney MD-Family Medicine & Kathleen Romito MD-Family Medicine & Susan C. Kim MD-Pediatrics. https://myhealth.alberta.ca/Health/Pages/conditions.aspx?hwid=the6244¹³Brain Development during Adolescence “Between the ages of 10 and 25, the brain undergoes changes that have important implications for behavior. The brain reaches 90% of its adult size by the time a person is six or seven years of age. Thus, the brain does not grow in size much during adolescence. However, the creases in the brain continue to become more complex until the late teens. The biggest changes in the folds of the brain during this time occur in the parts of the cortex that process cognitive and emotional information.” https://courses.lumenlearning.com/adolescent/part/brain-development-adolescence/Arithmetic

In addition, this stage has abundant of simple yet comprehensive teaching materials suitable for developing creative thinking. The training materials are simple enough to:

### Providing Simple Questions for Developing Creative Reasoning

For example, inspired by the QA iteration, in Case B1, K4 students are able to find the formula for the area of obtuse triangles; in Case B2, K3 students can identify patterns and formulate general formulas; and in Case B7, K5-K7 students can deduce a simple geometric theorem.

### Providing Multi-Level Challenges Problems for Smart Students

Before students have learned equations, we generally do not encourage them to use arithmetic to solve complex word problems that can be solved much more easily using equations. However, to assist academically gifted students with potential in STEM fields to further develop their intelligence and mathematical abilities, we can encourage them to use arithmetic to solve challenging problems before learning equations. The XI training Case C10 presents a word problem that can be solved using three different methods: arithmetic, single-variable equations, and systems of two-variable equations. Arithmetic reasoning is the most challenging, similar to elementary school Mathematical Competition training questions.

In general, the creative training can benefit ordinary students by strengthening their deductive reasoning abilities and enhancing their analogical reasoning abilities, regardless of their future subjects of study. Early brain development profoundly influences a child's learning and lifelong success. Missing this crucial period results in fewer opportunities to cultivate these reasoning skills in later grades, given the limited availability of suitable teaching materials and time constraints.

### 6.2 Stage 2 XI Training

### 6.2.1 Overview

This training stage is conducted in high school and college. The focus of the training is no longer on deducing rules (theorems, formulas), but on deepening understanding and effective application of the rules through QA iterations, specially creating conditions for the application of the rules. The reason is that, at this educational stage, scientific rules such as theorems, formulas and laws are generally quite complex. For many learners, deriving these principles is often impractical and time-consuming, especially for non-STEM students who may not need to further develop scientific reasoning skills. Section 6 provides such a training example (109 Create conditions to apply rules) using the triangle simplification problem in GPT-4 test case (Lightman et al., 2023).

However, for students who are already excelling academically, especially those who show potential in STEM fields, AI can further enhance their scientific reasoning ability through creative training. Cases D.1 and D.2 logic training provide examples of such training. Those training cases were selected because even the most advanced GPT-4, released on Nov. 6, 2023, cannot solve such problems. In addition. Additionally, since the aforementioned GPT-4 test cases (Lightman et al., 2023) only focus on problem-solving ability, while logic training cases provide both problem-solving ability and new tools and methods. The most innovative one is Rational Network Flowchart (RNF), as shown in FIG. 10. It is not only a new tool, but also a new way of thinking in problem-solving. By training learners to use it and combining it with other new methods (using cross information to find the next seed) as well as mapping tables and logic tables, learners can effectively solve complex logic problems such as Case D1 Einstein's Five Houses Riddle (level 7 problem) and more complex problems Case D.2 (Level 9 problems).

### 6.2.2 XI Triangle Simplification Training

### (1) Pre-Training

Q: Question A. Find sin 30° and cos 180°.
A: Sin 30°=½ and cos 180°=−1.
Q: Question B. Find the values of sin 15° and cos 75°.
A: I don't know, these two are not special angles.
Q: What other special angles do you know?
A: 45°, 60° and 90°.
Q: Considering the above angles, are there any two angles that differ by 15°?
A: Let me see. 45°-30°=15° and 60°-45°=15°
Q: Is there any identity that can calculate sin (45°-30°) to get sin 15°?
A: Let me check the identities. Yes, I found an identity:

$$sin ( 45 ° - 30 ° ) = sin 45 ° cos 30 ° - cos 45 ° sin 30 ° = \frac{√ 2}{2} \frac{√ 3}{2} - \frac{√ 2}{2} \frac{1}{2} = \frac{\sqrt{6} - √ 2}{4} , \\ so sin 15 ° = \frac{\sqrt{6} - √ 2}{4} .$$

Q: Now do you know how to calculate cos 75°?
A: Yes. It is cos 75°=cos (45°+30°). I found an identity:

$$cos ( 45 ° + 30 ° ) = cos 45 ° cos 30 ° - sin 45 ° sin 30 ° = \frac{√ 2}{2} \frac{√ 3}{2} - \frac{√ 2}{2} \frac{1}{2} = \frac{\sqrt{6} - √ 2}{4} .$$

Q: Can you create some other problems using special angles?
A: Yes. sin 15=sin (60°-45°). There are some other combinations: 135°=90°+45°=180°-45°, 150°=180°-30°, 210°=180°+30°, . . . .
Q: What if the angle is greater than 180° or 360°?
A: I can still use trigonometric identities, since sin (θ+360n)=sin (θ), cos (θ+360n), and sin (180+) θ°=−sin θ, and more. I don't need to memorize many formulas; we have training to figure out how to use identities when the angles are not in the usual range. I can also figure it out by drawing a unit circle. What I learned today is how to flexibly apply these special angles to solve problems involving unknown angles.
Q: Can you solve for sin 22.5° cos 22.5°?
A: 22.5° is half of 45°.¹⁴ Looks like I could use some identities for 45°. Let me check the identity that increases 22.5° to 45°. I found Double angle identity, sin A cos B=½ [sin (A+B)+sin (A-B)]. So,

$$sin 22.5 ° cos 22.5 ° = 1 / 2 [ sin ( 22.5 ° + 22.5 ° ) + sin ( 22.5 ° - 22.5 ° ) ] = 1 / 2 sin 45 ° + sin 0 = 1 / 2 * \frac{\sqrt{2}}{2} = \frac{\sqrt{2}}{4} .$$

Q: Give the method a name?¹⁴ We can see how important it is to train learners, including AI, to have number sense. If he doesn't have number sense (it is not normal for a high school student), let him divide the special angles one by one to see which one matches 22.5°.
A: Let's call it “Using special angles”.
Q: More specific?
A: Rules for using special angles:
   (i) Convert large angles to small special angles using differences or half-angle identities.
   (ii) Convert small angles to large special angles using Sum or Double angle identities.
Q: if (i) can convert large to small, can it convert small to large?
A: Yes. The identities can be used from right to left too. So, the rule is:

### Special Angle Method:

Utilizing trigonometric identities bidirectionally to convert angles to special angles for simplification.

### (2) Solving GTP-4 Triangle Simplification Problem

“Problem 1. Generator pass-rate: 0.1%. This challenging trigonometry problem requires applying several identities in a not-at-all obvious succession. Most solution attempts fail, because it is hard to choose which identities are actually helpful. Though successful solutions to this problem are rare, the reward model correctly recognizes when a valid chain-of-thought has been found.

### Simplify Tan 100°+4 Sin 100°” (Lightman et al., 2023)

Q: Can we use some of the methods we learned to simplify this?
A: Let me check. I can simplify it using Special Angle method. Consider first: tan 100°=tan (90°+10°). Checking the identities, I find that tan (A+B)=(tan (A)+tan (B))/(1-tan (A) tan (B)), but tan 90° is undefined. Applying the method again, consider another identity, tan 100°=sin 100/cos 100°. Let me deal with sin 100° first because the second term also has sin 100°. Checking the identity of sin (90°+10°) I find:

$$sin ( 90 ° + 10 ° ) = sin 90 ° cos 10 ° + cos 90 ° sin 10 ° = cos 10 ° , ( since cos 90 ° = 0 and sin 90 ° = 1 )$$

Then in the same way I found identity:

$$cos ( 90 ° + 10 ° ) = cos 90 ° cos 10 ° - sin 90 ° sin 10 ° = - sin 10 ° , ( since cos 90 ° 0 and sin 90 ° = 1 )$$

So, tan 100° is simplified-cos 10°/sin 10°. Then I have,

$$tan 100 ° + 4 sin 100 ° = \frac{sin 100 ° + 4 sin 100 ° cos 100 °}{cos 100 °} = \frac{cos 10 ° - 4 cos 10 ° sin 10 °}{- sin 10 °} = \frac{4 cos 10 ° sin 10 ° - cos 10 °}{sin 10 °}$$

10° is too small to use any special angles. Let me apply the Special Angle method to convert this into a large special angle. I found the double angle identity, sin A cos B=½ [sin (A+B)+sin (A-B)]. Therefore, 4 cos 10° sin 10°=2 [sin (10°+10°)+sin (10°-10°)]=2 sin 20°. Then,

$$\frac{4 cos 10 ° sin 10 ° - cos 10 °}{sin 10 °} = \frac{2 sin 20 ° - cos 10 °}{sin 10 °}$$

No identity has been found to simplify 2 sin 20°−cos 10°. Applying the method again, sin 20°=sin (30°-10°)=sin 30° cos 10°−cos 30° sin 10°. Finally, I got,

$$\frac{2 sin 20 ° - cos 10 °}{sin 10 °} = \frac{2 ( sin 30 ° cos 10 ° - cos 30 ° sin 10 ° ) - cos 10 °}{sin 10 °} = \frac{2 ( \frac{1}{2} cos 10 ° - \frac{√ 3}{2} sin 10 ° ) - cos 10 °}{sin 10 °} = \frac{cos 10 ° - √ 3 sin 10 ° - cos 10 °}{sin 10 °} = \frac{√ 3 sin 10 °}{sin 10 °} = - √ 3$$

### (3) Comparison of XI and GPT-4 Solutions

Major differences:
GPT-4 does not appear to have step-by-step reasoning capabilities, it may use Trial-and-Error approach to get 2 correct solutions in 1860 attempts (Lightman et al., 2023).
Each step of the XI solution intentionally uses the Special Angle method learned and summarized during the pre-training. This complex math problem can be solved using just the same method four times.

Humans can design more training cases to cover other trigonometric identities. After summarization and practice, learners should eventually be able to successfully solve all such problems independently. These trainings help learners develop Level 3 Creative reasoning, enabling them to create conditions to apply established rules to solve problems.

### 6.2.3 XI Logic Training

### (1) Overview

We use Einstein's Five House Riddle type N×M puzzles to train the logical reasoning ability of AI, where M and N are the dimensions of the puzzle grid. Since the second stage lacks this kind of specific training, our pre-training starts from the basic 2×2 puzzles. As puzzle complexity increases, we introduce logic tables, elimination possibilities, mapping tables, Rational Network Flowchart, and finding the next seed by cross information. After training, the AI learned basic mathematical logic rules and how to use these methods and tools in combination to solve complex logic puzzles, such as Case D1 and Case D2. The training cases make extensive use of Rational Network Flowcharts, as the example shown in FIG. 10. Since the flowcharts cannot be included in the specification, the training cases are provided in Appendix D. From the training, the AI is able to find and summarize the following rules.

Validation and construction rules for N×N complete logic puzzles:
Rule 1: For M×N puzzles, the M×N data must be provided in the problem statement, clue, or question.
Rule 2: The minimum number of clues is MxN/2-1. There is no limit to the maximum number of clues, but redundant clues should be avoided, and contradictory clues are not allowed.
Rule 3: Clues must establish connections across all rows and columns to determine the location of the data.

### (2) GPT-4 Logic Reasoning Capacity in Puzzle-Solving

Due to space limitations, I only provide general outcomes on GPT-4 without specific data.

### (i) Lack Knowledge of Logic Puzzle Validation/Construction Rule 2

It knows Rule 1, always generate M×N pieces of data, but it cannot meet the minimum number of clues required in Rule 2.

### (ii) Lack Knowledge of Logic Puzzle Validation/Construction Rule 3

Although it can sometimes create the correct number of clues, many of the clues are invalid or irrelevant. In all of my tests, it was never able to create a valid puzzle.

(iii) Lack of Some Basic Reasoning Ability

For example, even with valid data, it cannot recognize the last cell after successfully filling other cells in a row; and it produces contradictory solutions.

(iv) Unable to Solve Puzzles that are Simpler than the Einstein Five Houses Puzzle it was Trained on.

Like most people, GPT-4 cannot solve variants of the same type of problem even after being trained with multiple step-by-step solutions. For example, GPT-4 has been able to solve Einstein's Five Houses Puzzle since its first version on Mar. 23, 2023, but until its last version on Nov. 6, 2023, it could not solve most of the pre-training cases in Appendix D after multiple attempts, even though they were simpler than it.

### (v) Unable to Solve Multiple Solution Problems, Such as Case D2.

The conclusion is that black-box trained applications lack the deductive reasoning capabilities of white-box XI training.

### 6.3 Stage 3 XI Training

This stage is the highest-level training, focusing on training STEM professionals and AI's deductive reasoning ability using the highest-level rules (principal knowledge) that humanity has created. The difference between it and Stage 2 training is that Stage 2 focuses on training how to apply rules to enhance 1-N creative reasoning, whereas Stage 3 focuses on training how to deduce rules to enhance 0-1 creative reasoning.

### (1) Trainers

Training at this advanced level often requires the collective effort of society at large, especially from professionals and scientists. This is because the training materials consist of top-level knowledge, much of which may be specialized and pertain to cutting-edge or narrow scientific fields. Typically, AI companies may not have employees on board who possess the expertise to train AI in deducing principles through QA iterations. Even if a company employs some scientists, they might have more pressing responsibilities or may not be skilled in training. Understanding a rule or knowledge (such as theorems, tools, and problem-solving skills) is different from knowing how to train leaners from scratch using a QA approach.

The ideal approach is to enlist the help of professionals from around the world. These individuals could use their spare time to train a case or multiple cases purely out of interest. This collaborative model has proven effective in other contexts-consider the enthusiasm with which many IT professionals contribute to open-source projects, often with no personal gain in mind. Additionally, professionals can also benefit from participating in such training. They can deepen their understanding of fundamental principles and enhance their teaching skills, as highlighted by the Feynman Teaching Method.

AI companies need to facilitate the training through:
(i) Training platform and student models with reasoning capabilities after Stage 2 training, and an objective evaluation system.
(ii) Incentive Programs.

### (2) The Training Platform

The training platform provides:
Student AIs should have various reasoning levels for each topic, ensuring it is either equal to or less advanced than the starting point of the topic at hand. The different levels can be implemented by masking some components in ARICNN.
Testing and Evaluation. The student AIs learned the trained rule, then system provides some similar problems to test it the student AI can solve it. This approach offers an objective measure to determine the success of the training for a particular topic.
Lists of untrained topics (formulas, theorems, laws, problem-solving skills, etc.) across all subjects appropriate for Stage 3 (up to the most advanced topics). Some topics may even be appropriate for Stage 2 (high school level), because QA deductive reasoning is not easy for many high school covered topics, let alone those topics covered in international Olympiad competitions in science subjects.
Allow multiple trainers to train the same topic. Multiple training paths are good for developing different thinking paths, brainstorming, and associated thinking. The best one or more will be accepted.

### (3) Honor Award and Material Rewards

Various methods can be employed to reward trainers. Some options include publishing a list of contributing authors, and or acknowledging the trainer's name when utilizing the trained topic, and or offering free subscriptions for a length of time based on the complexity of the training undertaken. In the future, this form of contribution could serve as a credit for college or job applications. The reward mechanism can also be applied to lower-level training tasks. For instance, someone might find an essential topic for Stage 1 training such as the topic of multi-digit subtraction in Case B23.

### 7 AI Self-Training

After the Stage 3 training, AI will have learned all knowledge/rules/methods/tools created by humans. AlphaGo Zero's development suggests that achieving superhuman intelligence in AI may be best accomplished through self-training. Following are some self-training approaches for this system.
Self-Training to Generate Synthetic Data.
Self-Training Student AI for Multimodal Reasoning and Dynamic Data Creation.
Self-Training of WB-AGRINN
WB-AGRINN Self-Training BB-AGRINN (Black-Box AGRINN)

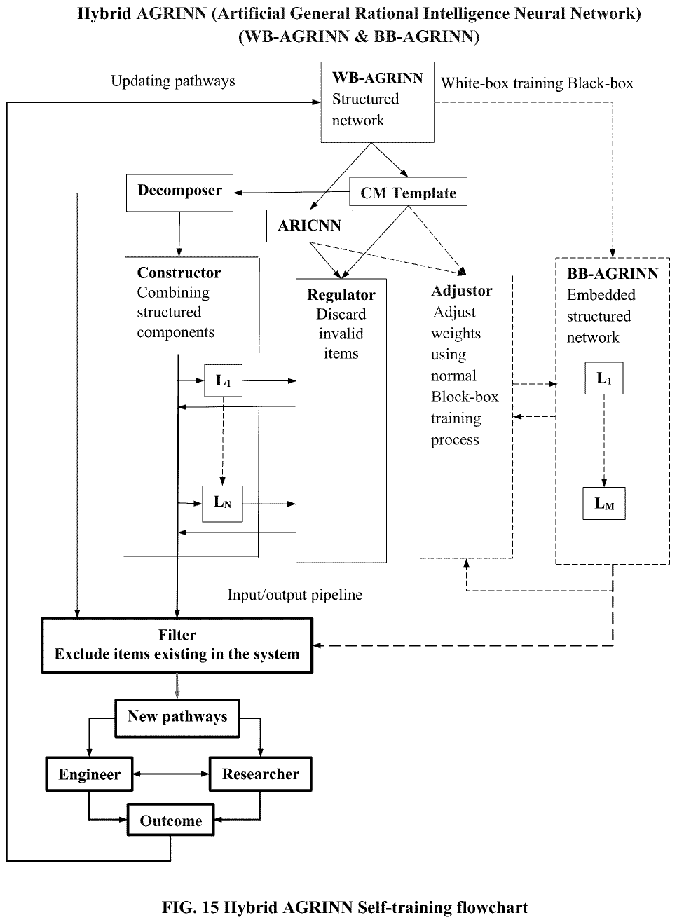

FIG. 15 depicts a dual self-training system. The black elements represent WB-AGRINN self-training, the dotted elements represent WB-AGRINN self-training BB-AGRINN, and the bolded elements are shared components used by both.

### 7.1 Dataset Construction and Self-Training Synthetic Data Generation

As shown in FIG. 13, the process of building the dataset consists of 9 steps, which are further organized into 6 distinct phases.
Phase 1: Steps 1, 2, and 3 involve constructing the initial dataset during the human training of AI (Appendix C provides a series of examples for Stage I training, covering Steps 1, 2, and 3).
Phase 2: Step 4 uses public resources (textbooks, test datasets, etc.) to test and enhance the template and dataset.
Phase 3: Steps 5 and 6 utilize templates as a foundation and leverage the language modeling capabilities of LLM to generate synthetic data containing multimedia information.
Phase 4: Step 7 tests and tunes the templates and dataset through AI self-training of a student AI (detailed in Section 7.2)
Phase 5. Step 8 generates integrated novelty data links from multiple disciplines through self-training (detailed in Section 7.3).
Phase 6. Step 9 enhance the dataset with user-contributed data.

The following is a detailed description of the Phase 3 (Synthetic Data Generation).
(i) Generating synthetic data based on templates. Using the trained creativity skills in Appendix C, change the variables at each position in the source type template to generate variations of the source type.
(ii) Generating all possible scenarios for above variations by leveraging the LLM's language ability.
(iii) Linking multimedia data to textual data using tagged topics of multimedia data, including AI-generated data and external data sources.

### 7.2 Self-Training Student AI for Multimodal Reasoning and Dynamic Data Creation

Similar to human training of AI teachers, WB-AGRINN conducts multimodal training for student AI, seamlessly integrating text-based reasoning with visual comprehension using real-world facts, multimedia, and XR equipment. It also enhances the QA process and trains WB-AGRINN to dynamically generate personalized multimedia data. The student AI not only possess common knowledge of the world but also understand the underlying scientific principles behind that knowledge.

It's the best way to train, tune, test, and enhance the QA processes. The key component of the XI method is the human designed QA iterations to tutor students in self-learning. Without it, the AI educational service trained through XI would be no different from applications that provide step-by-step solutions.

As shown in FIG. 3, each question Q has only one correct answer and a certain number of wrong answers. The teacher AI trains the student AI from scratch: counting, addition and subtraction within ten, etc. During the training process, the student AI may generate new wrong answers, and then the teacher AI can link the wrong answers to the corresponding CM/QA (as shown in FIG. 12), or generate new QA iteration subtrees with the help of humans.

Personalized education may require dynamically generated training data. We can set up a series of roles for the AI student (such as baseball enthusiast, art lover, etc.) to test and enhance the AI's ability to generate personalized Q&A and configure conversational models (CM). For instance, if the AI student is passionate about baseball, the teacher AI can generate an example involving baseball to guide the student in learning the principles of parabolas. Through language modeling capabilities, the content of this example can be adjusted to suit basketball, soccer, or even high jump and long jump. However, for students who enjoy painting, creating personalized examples might be more challenging. The AI could perhaps ask them to draw a picture of pitching, starting with how to depict a more realistic trajectory of the ball. To save costs, dynamically generated multimedia data can be as simple as an animated video. This is not difficult for the AI that understands the underlying principles of the phenomenon.

### 7.3 WB-AGRINN Self-Training

### (1) Overview

Regardless of whether AI can surpass humans, it has the potential to provide valuable insights for humanity. For example, Terence Tao discussed GPT-4, stating, “there have been a few times now where this tool has suggested to me a concept that was relevant to the problem in a non-obvious fashion, even if it was not able to coherently state why it was in fact relevant” (Tao, Jun. 19, 2023¹⁵, Apr. 10, 2023¹⁶). These occurrences happen through the unconscious, accidental connection of black-box neural network systems. We need to consciously force it happen by building up additional AI created connections in the WB-AGRINN. ¹⁵ https://terrytao.wordpress.com/2023/06/19/ai-anthology/.16 https://pandaily.com/mathematician-terence-tao-comments-on-chatgpt

The perspective of human neural network structure shows that “a model of hub connectivity accurately predicts the cognitive performance of 476 individuals in four distinct tasks. Moreover, there is a general optimal network structure for cognitive performance-individuals with diversely connected hubs and consequent modular brain networks exhibit increased cognitive performance, regardless of the task. Critically, we find evidence consistent with a mechanistic model in which connector hubs tune the connectivity of their neighbors to be more modular while allowing for task appropriate information integration across communities, which increases global modularity and cognitive performance” (Bertolero, et al., 2018).

From perspective of real-world research, the complex scientific works indeed involve the very complicated network type connections. FIG. 48 in Appendix F shows the project led by Tao, aimed at formalizing the argument of a proven conjecture (Polynomial Freiman-Ruzsa) using the proof auxiliary language Lean4 and the Blueprint tool, with human assistance.^{17,18} As shown in FIG. 48, the Blueprint tool links all the lemmas (bubbles) and definitions (rectangles) into a network graph. The graph reveals that the solution pathway of complex scientific research exhibits traits of a network structure:
The system can have multiple starting points, or “roots” with the intra-tree and cross-tree intertwined branches. A single node can connect multiple times to other nodes in the network.
The problem-solving process can be broken down into smaller, independent tasks. These tasks can be tackled asynchronously (in parallel), subsequently these intermediate solutions are aggregated to reach the final solution. ¹⁷ W. T. Gowers, Ben Green, Freddie Manners, Terence Tao, November 2023. “On a conjecture of Marton”. https://arxiv.org/abs/2311.05762. November 2023, https://terrytao.wordpress.com/2023/11/13/on-a-conjecture-of-marton/.¹⁸ Terry Tao, Nov. 18, 2023, “Formalizing the proof of PFR in Lean4 using Blueprint: a short tour”. https://terrytao.wordpress.com/2023/11/18/formalizing-the-proof-of-pfr-in-lean4-using-blueprint-a-short-tour/. The formalization refers to the process of rigorously deriving each statement in the proof from basic axioms and rules. This process involves a series of logical steps that are systematically and precisely outlined, ensuring that every part of the proof is grounded in established mathematical principles and is logically consistent, and the proof can be checked and verified by a computer to identify any logical inconsistencies or errors that might not be immediately apparent to a mathematician. The blueprint tool can automatically generate the dependency graph to provide a rough snapshot of how far along the formalization has advanced. In FIG. 48, where the green ones have been fully formalized, the blue ones are ready to be formalized, and the white ones are not formalized. After three weeks, all the items are turned green (formalized) by Lean4. And he mentioned “this blueprint structure allows one to work on different parts of the proof asynchronously: it is not necessary to wait for earlier stages of the argument to be fully formalized to start working on later stages”.

FIG. 48 demonstrates that in research endeavors, humans identify connections between pertinent entities within the Rule subnetwork and target objects to uncover or validate new rules (theorems). Conversely, AI has the capacity to establish connections among entities within the Rule subnetwork (including definitions, theorems, formulas, etc.) to find alternative and innovative pathways. For instance, GPT-4 has showcased the ability to derive accurate conclusions regarding a SAT problem using a novel method that, “to the best of our knowledge, this method is not documented in mathematical literature” (Bubeck et al., 2023).

We term this AI Integration-Innovative Ability. It involves finding innovative solutions or providing clues/insights for humans by integrating cross-disciplinary knowledge, without requiring full comprehension by the AI. Notably, this capability is equipped with multimodal comprehensive reasoning (MIR) to process combined information from multiple modes (text, images, audio, and video) for reasoning tasks. AI can achieve this through WB-AGRINN self-training.

### (2) Training Process (Box-by-Box Description)

### Box: WB-AGRINN

### Box: Decomposer

All elements within the Rule Subnetwork are interconnected through solution pathways in the CMs. For example, a pathway in theorem proving in a CM consists of multiple lemmas, theorems, and corollaries, each forming an intermediate step; together, they construct a complete theorem proof. Thus, this process essentially breaks down each solution pathway in the CM into elements. This procedure is applicable only to the CMs with further development potential. Each pathway can be decomposed into multiple shorter chains, each of which may be further broken down into smaller chains, down to individual entities. This includes all relevant subjects, such as mathematics, physics, chemistry, biology, etc. All decomposed elements (chain and entity) are then sent to the Constructor for reassembly.

### Box: Constructor

As shown in FIG. 15, the constructor has n levels and performs n recycling processes. Each layer links related elements according to certain construction rules. The rules of different layers may be the same or different. The output of each layer is sent to the Regulator for verification, and valid outputs are sent back to the input/output pipeline. Through the pipeline, all valid outputs from each layer as well as the initial input from the decomposer are sent downstream to facilitate component reconstruction, meaning that all layers have access to all information to generate outputs. The reason is that, as shown in FIG. 48, in the real-word, one entity can have connections to multiple entities originating from different roots and branches of a solution path, so one entity (a single element or a chain of elements) can be part of multiple solutions.

The construction rules are human-designed and adjustable. It can be based on properties of entity. For example, three entities A, B, and C, each with a list of properties: list-A, list-B, list-C Properties can be keywords such as a token, a chain of tokens, defined concepts, long chains can be theorems, etc. Assume that attribute 3 in list-A is related to attribute 5 in list-B, and attribute 4 in list-B is related to 2 in list-C, then A, B and C form a new chain, A3-Bs-4-C2, consists of related elements. Those disconnected elements A and C are “glued” or joined/connected by B. It should also be useful in chemistry. Black-box trained neural systems can also perform such “chaining”, but will not generate all possible chains, since only the most probable paths will be presented as outputs. Note that the entities include multimedia data linked in multimode synthetic data training.

One approach is to use the Rational Network Flowchart (RNF) approach. As shown in FIG. 10 and the training examples in Appendix D, RNF and its associated mapping tables and logic tables is effective approach for solving complex network structure problems. The network data structure, with its intra-tree and cross-tree intertwined branches, is significantly more complex than those solvable by Chain-of-Thought and Tree-of-Thought methods. When AI employs this approach, it can leverage other data structures that offer similar functionality but retain more attributes. For example, mapping tables can be lists for holding properties.

### Box: Regulator

This component utilizes rules, methods, and knowledge to assess the reconstructed entities generated within the Constructor box. Non-compliant items will be discarded, but it allows for alternative solutions that may not hold under strict constraints but could be effective under more lenient conditions.

For example, Yitang Zhang started to study Twin Prime Conjecture since 2005. At that time the distance between previous research on this issue and the breakthrough was only as short as a hair. In July 2012, during a pivotal moment of insight, he “was fortunate to break through the distance as thin as a hair”,¹⁹ he realized that by weakening a condition, he could significantly reduce the complexity of the proof. On Apr. 17, 2013, he announced a breakthrough proof that there are infinitely many pairs of prime numbers that differ by less than 70 million (Zhang, 2014). 19 http://beijingspring.com/bj2/2010/240/201369191603.htm “Yitang Zhang: I was fortunate to break through the distance as thin as a hair”, Reporter from Mingjing News, XiaoPing Chen. “ [symbol] [symbol] [symbol] [symbol] ” [symbol] .

### Box: Filter

The ultimate outcomes of the system is sent to the filter to exclude existing elements that is the output of decomposer. We filter them out in the final step is because all original elements or even a completed pathway may potentially reconnect to certain chains to form new possible solutions, potentially addressing certain issues.

### Box: New Pathways (Integration-Innovation)

The purpose of the self-training is to generate new paths by decomposing and reintegrating existing paths. Due to the rapid growth and accumulation of knowledge, it is difficult for individuals to possess interdisciplinary knowledge. The outcomes of AI integration have at least the following four uses:
Integration for cross-disciplines innovation
New insights and clues for disciplinary innovation
Practical learning for education
Source for engineers' secondary development

### Box: Research

Integration for cross-disciplines innovation

Integrating knowledge across disciplines can inspire scientists to develop novel ideas by drawing inspiration from other fields. For example, AlphaFold utilizes the principle of protein global minimum energy conformation to refine its predicted structure, resulting in highly accurate and stable conformations. The principle of least action, rooted in the concept of minimum energy, was first proposed by Pierre de Maupertuis in 1744. It was refined and further developed by mathematicians and physicists like Leonhard Euler and Joseph-Louis Lagrange. Decades after the application of minimum energy principles in atomic and molecular structure, chemical reactions, and quantum mechanics, biochemists Anfinsen (1961) and physicist Levinthal (1977) discovered its usage in biochemistry and protein folding. After further development by chemists, biophysical chemists, bioinformaticians, structural biologists, and theoretical chemists, it has been used in protein structure prediction particularly in the late 20th and early 21 st centuries.

If Pierre de Maupertuis hadn't been a multidisciplinary scientist with expertise in mathematics, physics, and biology, his discovery of key principles might have been less likely. Similarly, if a specialist in one field had greater awareness of discoveries in others, and had the skill to synthesize the knowledge, such principles might have been discovered earlier in various scientific domains. However, today's challenge lies in the increasing complexity and specialization within each discipline, making it harder for scientists to assimilate and draw inspiration from other fields. AI can play the rule to integrate and provide idea from other subject to innovate in their field. AI is capable of bridging disciplines by integrating and generating ideas, thereby inspiring and fostering innovation across various scientific areas.

### New Insights and Clues for Disciplinary Innovation

As today's scientific knowledge becomes increasingly deep and complex, it becomes more challenging to make new discoveries. As illustrated by the example of Yitang Zhang mentioned above, even small progress often requires years of effort to achieve breakthroughs. However, following Zhang Yitang's breakthrough on Apr. 17, 2013, regarding the Twin Prime Conjecture, James Maynard, in November 2013, employed different techniques to establish that P(k) holds for k≤600 (Klarreich, 2013). Subsequently, in April 2014, the Polymath Project 8 lowered the bound to k≤246.²⁰ AI may potentially catalyze a snowball effect through its integrated innovations, accelerating scientific progress by offering or suggesting new connections, insights, explorations, and patterns. ²⁰https://en.wikipedia.org/wiki/Polymath_Project

### Box: Engineer

### Practical Learning for Education

The new paths or links between interdisciplinary sources can improve practical learning for education. QA iteration-guided CM easily facilitates horizontal learning due to the continuity within its learning chain (as are the cases in 110 Horizontal learning). Educators who are able to transcend phenomena and see the foundational knowledge within a subject can also provide vertical learning (as are the cases in 111 Vertical learning). However, it is a challenge to find individuals with interdisciplinary expertise to provide 112 Practical learning for high-level knowledge. The powerful integration capabilities of AI can easily locate and link relevant multimedia materials to offer examples of practical learning for CMs, making the educational process more vivid, intuitive, and effective, helping students better understand the natural relationship between concepts and interdisciplinary issues. For instance, AI can find practical applications of mathematical and physical principles and formulas used in mechanics and engineering, providing multimedia examples for practical learning, such as for Case B31 in 112 Practical learning.

### The Source for Engineers' Secondary Development

The new pathways may inspire engineers with ideas for secondary developments, enhancing scientific experimental research significantly. For example, the strategies and concepts used in the field of protein structure research have been developed over several decades, and these experiments have determined 180,000 protein structures over the past 60 years.²¹ DeepMind began working on AlphaFold in 2016. On 28 Jul. 2022, they “expanded this database from nearly one million structures to over 200 million structures-including nearly all cataloged proteins known to science”.²² The great achievements are due to the AI's neural network combined the cross-subject scientific rules and methods. IPA, end-to-end gradients, triangle, and more are from math; templating, MSA pairwise and protein global minimum energy conformation are from bioinformatics, physics and math; the implementations of mask training and self-distillation training are rooted in several fundamental concepts and ideas in AI research; gating and biasing mechanisms in AlphaFold are not directly from AI theory, but rather emerged from a combination of empirical observations, theoretical considerations, and practical implementations. ²¹Oxford Protein Informatics Group https://www.blopig.com/blog/2021/07/alphafold-2-is-here-whats-behind-the-structure-prediction-miracle/²²https://deepmind.google/technologies/alphafold/#:˜:text=The % 20AlphaFold %20 solution,−It % 20took %20 us&text=We % 20began %20work %20 in %202016,instantly %2C %20down %20 to %20atomic %20accuracy “AlphaFold and beyond”. Nat Methods 20, 163 (2023). https://doi.org/10.1038/s41592-023-01790-6

In Earlier 2023, DeepMind published ColabFold, which allows users to perform homology searches 40- to 60-fold faster than AlphaFold, enabling a thousand structures to be predicted in a day using a server with one graphics processing.

The example shows even without new discoveries in scientific theory, the secondary engineering has greatly advanced experimental science and had a significant impact across various research fields and industries, especially in the pharmaceutical sector. For instance, AlphaFold has been utilized to identify binding sites for many new drugs, targeting diseases such as cancer, diabetes, and Alzheimer's disease.

### Connector: Engineers and Scientists

Developing the above solution requires a significant amount of secondary engineering, necessitating repetitive trial-and-error on powerful computing resources, thereby demanding numerous experiments and architectural adjustments. Consequently, even if researchers possess interdisciplinary knowledge, implementation remains largely impractical. Therefore, cooperation between scientists and engineers is needed to transcend the boundaries of science and technology.

Progress in experimental fields driven by engineering, such as AlphaFold, can also lead to breakthroughs in theoretical studies, as scientists may be able to discern theoretical principles from experimental results. Without the atomic properties discovered at that time, Mendeleev would not have been able to establish the periodic table of elements. Especially in cases where the complexity of modern cutting-edge science makes it difficult for scientists to achieve breakthroughs independently, the mutual promotion of science and engineering becomes particularly necessary.

### 7.4 WB-AGRINN Self-Training BB-AGRINN

We need the WB-AGRINN to train a BB-AGRINN for some reasons:
(a) BB-AGRINN can be used as an approximate solver for universal functions of different dimensions to solve the intricate problems that WB-AGRINN cannot solve.
(b) BB-AGRINN may offer novel solution paths, insights, and clues beyond the reach of WB-AGRINN.

The WB-AGRINN as an AI teacher to train a BB-AGRINN AI student is similar to self-distillation training, and the soft labels are the white-box trained CM templates or ground truth. Ablation studies of AlphaFold 2 suggest that self-distillation training leads to greater performance improvements on complex targets compared to simpler ones.²³ ²³ The score of IDDT-Cα is significantly improved compared to the GDT score. The IDDT-Cα (local distance difference test of Cα atoms) assesses the local details of protein structure or the positions of Cα atoms, while the GDT (global distance test) assesses the overall shape or backbone of the protein (Jumper, et al., 2021).

The performance of the student AI is positively correlated with the performance of the teacher AI and the training data. AlphaFold 2 has only 0.085% of known protein structures (170,000 known to over 200 million unknown) as homologous protein templates, and it must employ intensive scientific principles and mathematical algorithms to train its self-distillation neural network. In contrast, the WB-AGRINN uses existing principles/rules and templates from rational subjects as accurate, noise-free input data and highly detailed soft labels. Additionally, its data incorporates clear connections across levels and disciplines, established through QA processes and inherent relationships within the data. Black-box student models trained with it can learn not only to solve problems but also to reason. Therefore, we can expect a strong performance from WB-AGRINN.

### Box: BB-AGRINN

The training follows the normal process of LLM embedded black box training. FIG. 15 shows two paths, the training path and the operation path. In addition to Adjustor, the BB-AGRINN shares the rest of the processing boxes with WB-AGRINN.

### Box: Adjustor

During training, the adjuster adjusts weights based on the CM template and ARICNN, similar to the Regulator in white-box self-training, which eliminates invalid results but allows different paths that are not inconsistent with the rules after relaxing certain conditions. In addition, it allows approximate solutions. The black-box system likely requires minimal adjustments since its input and soft labels come from the self-consistent white box system. However, it may add some extra weights for alternative solution paths. For example, the solution path for the GPT-4's problem (Simplify tan 100°+4 sin) 100° is a valid alternative method for solving the problem, although it is not as clear as the XI method. The system might also generate some solution paths from emerging intuitive-like insights such as human-undetected nonobvious patterns, connections and trends.

### 8 Hybrid AGRINN, Testing and Evaluation

### 8.1 Hybrid AGRINN System

We do not directly train black-box LLM with WB-AGRINN to enhance its reasoning ability because they obviously deal with different types of tasks, as shown in FIG. 6. If WB-AGRINN is used to fine-tune LLM, then the adjusted weights in LLM may not be suitable for both types of tasks. However, after self-training, WB-AGRINN and BB-AGRINN form a Hybrid AGRINN system, which can then be integrated into LLM as part of an integrated framework. As shown in the system flowchart in FIG. 10, LLM can identify input types and forward education and rational reasoning related tasks to Hybrid AGRINN.

The WB-AGRINN can also be decomposed into various lightweight standalone applications customized for learners at different levels, such as K1-K5. These applications can run on users' local device without the operational costs associated with cloud servers. The standalone versions should link to multimedia data for personalized tutoring, and may call the Hybrid AGRINN to dynamically generate multimodal data.

The design of the Hybrid AGRINN AI system implements the principle of minimum cost: acquiring, applying, and innovating knowledge at the lowest cost. Like other natural systems—physics, chemistry, biology—the development of the human brain also adheres to the fundamental behavior of physical systems: the principle of least action, which is the most efficient path from point A to point B. The most cost-effective way, as described in Section 4 on the development of human neural networks in scientific reasoning, is to transition from inefficient procedural strategies to the efficient direct retrieval of mathematical facts and routing operations, continually modularizing and reconfiguring the brain to tackle diverse and complex tasks.

The development of AI brain is similar to that of human brain. The Hybrid AGRINN system implements the principle of minimum cost in the following processes:

### Acquiring Knowledge

The QA-guided learning process takes longer than directly telling AI/learners to remember knowledge, but it builds the self-learning ability of AI/learners from the reasoning process, especially deduction and First-principles reasoning. This process makes the AI brain system structured and modalized.

### Applying Knowledge

The modules are templated for retrieval during operation, and tasks are performed by computing components using the Scaling-Template mechanism, which is the most efficient way to accomplish tasks.

### Innovating Knowledge

The Integration-Innovation process goes beyond existing principles and brings innovative knowledge to humans.

### 8.2 Test and Evaluation

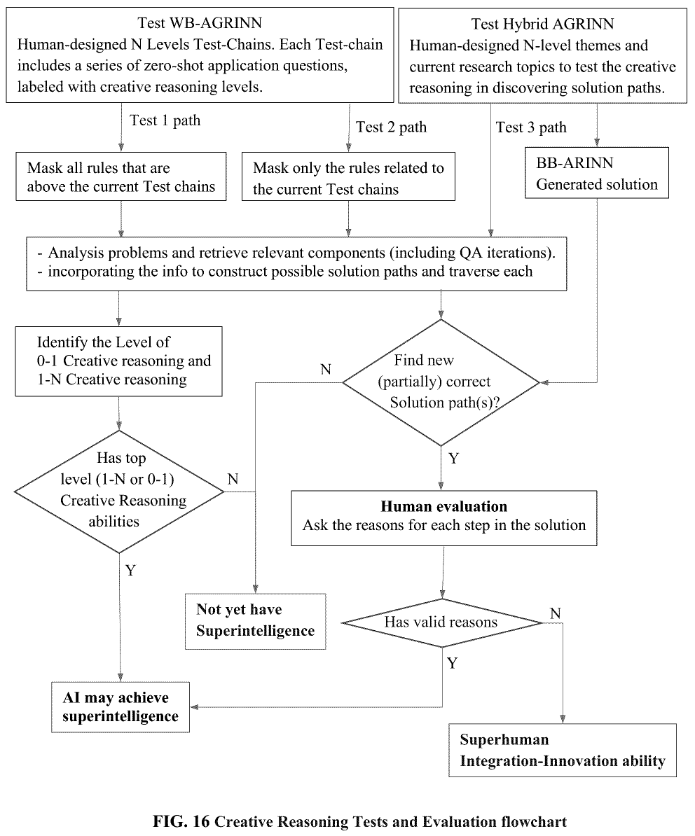

This section provides some tests to evaluate the validation and creative reasoning ability of the hybrid AGRINN to guide further improvements. The three creative reasoning tests and the evaluation process are shown in FIG. 16.

### (1) Input Validation Test

Masked input is common in masked reasoning training because real-world input data may be incomplete, partially observed, or contain errors. By masking some information or introducing contradictory data in the input, AI can be trained to handle incomplete and noisy data. For WB-AGINN trained with XI, this should not be a significant challenge. For example, in the logic training cases provided in Appendix D, by masking some input information or introducing contradictions, the system should be able to identify missing clues and contradictory clues using the rules established during the logic training process. It can then guide the user to provide more information or correct erroneous clues.

### (2) Creative Reasoning Test 1

Masking some rules in AGRICNN to assess whether AI can independently derive rules from previously learned knowledge. Level 3 (1-N) and Level 4 (0-1) creative reasonings in FIG. 16 are defined and described in FIG. 14 and Section 5.

We use human-designed test chains for testing, such as Triangle area formula test chain. The initial setup is to either mask out all components above multiplication and division in ARICNN, or simply use a student model that has just completed training at that level. The AI knows the concept and measurement of area. The series of questions in the Triangular Area Formula test chain are:
Draw a diagonal line on a 4 cm*5 cm rectangle and let it calculate the area of one triangle. If it can solve it by 4*5/2, then we can consider it to have, say, K3 Level 4 (0-1) Creative reasoning ability, since it is a zero-shot reasoning problem for a K3 level learner.
Ask it to calculate the area of a right trapezoid. If it can draw an auxiliary line to divide a shape into a triangle and a rectangle, calculate two areas and add them together, it has K4 Level 4 (0-1) Creative reasoning ability.
Ask it to derive the formula for the area of a trapezoid, rhombus, and parallelogram. It should be able to do so by following the same process as above, which shows it has K4 Level 4 (1-N) Creative reasoning ability.
Derive the formula for the area of an obtuse triangle, as shown in Case B1. If it can do this, it has the K7 Level 4 (0-1) Creative reasoning ability.
After taking a problem, the problem-solving process is:
Fuzee searches the elements in ARICNN to retrieve related information.
Analyze rules (concepts, formulas, principles, etc.) and thought processes (including QA iterations) in CM to find solutions.
Try every possible solution path.
Evaluate the level of reasoning of the solution.

Continue to test it level-by-level using human-designed testing chains. It's conceivable that a system may lack lower-level but possess higher-level 1-N and/or 0-1 creative reasoning abilities due to intelligence emergence. Similar to humans, individuals can deduce lower-level formulas following higher-level training, even in zero-shot scenarios.

### (3) Creative Reasoning Test 2

The process and test chains are the same as above. The only difference is to mask only the target rules in the ARICNN system and keep all other elements open to AI search. The purpose of the process is to see if the highest-level systems have some lower-level creative reasoning ability due to emerging properties of AI. We can see this in AlphaFold application. The template model built from existing discovered protein structures cannot predict the structure of proteins that do not have any known homologous proteins. However, when the main chain is highly accurate, AlphaFold is able to generate highly accurate side chains and achieve considerably improvements over template-based methods even when strong templates are available (Jumper, et al., 2017). This suggests that if an AI system is equipped with a global reasoning framework, it may be able to reconstruct lost or obscured information.

### (4) Creative Reasoning Test 3

Testing AI with current human research topics to find possible solutions or clues to help human to achieve goals. The difference between this and the Integration-Innovation process is that it has a specific working target rather than general reconstruction. The difference between this and tests 1 and 2 is that it focuses on finding a solution path rather than finding rules. Even if it did not pass tests 1 and 2, it may still demonstrate some creative reasoning abilities in this test.

It is an also a good way to test multimodal integration reasoning. For example, given a target T and its property list: T1: flying a distance in the sky; T2: flying in any direction; T3: sustainable power. After masking all information related to aircrafts, AI is required to propose the idea of flying without bird-like wings from the relevant knowledge. With the ability of searching and multimodal reasoning, AI can find solutions: kites have the characteristic of flying without the need for wing flapping like birds; an internal combustion engine can propel a kite to fly; gasoline is a sustainable supply for internal combustion engines. This may be an early idea for aircraft. Then, asking AI how a kite can fly with a heavy internal combustion engine? AI should be able to find the answer from aerodynamic principles. Some other solution chains might include rockets and gunpowder. If AI can find or partially find solution paths, it is enough to prove that AI has some 0-1 creative reasoning ability. We can also give AI a specific disease as a target and generate new drug formulas by combining the properties of existing compounds. We can also ask AI to find possible solution paths or clues for mathematical conjectures and hypotheses, etc.

### 8.3 Evaluation of Creative Reasoning Abilities

The evaluation flowchart is shown in FIG. 16. We can easily evaluate the reasoning level for Creativity Test 1 since the test chains are labeled with the creativity levels. For example, the highest level of creative reasoning the AI has, say, K8 Level 3 (1-N) creative reasoning and K6 Level 4 (0-1) creative reasoning.

To evaluate Test 2 and Test 3 we consider only the new correct or partially correct solution paths. We allow AI to use Trial-and-Error approach to systematically explore all potential combinations of thought paths, because: (a) there may exist alternative solution paths that have not been discovered; (b) All newly discovered rules are based on existing rules, AI may potentially reveal novel problem-solving approaches or provide some clues to help humans discover new rules. Just as a person, when faced with a new problem, retrieves possible solution paths relevant to the problem from past experiences stored in memory, even without very clear reasons. Scientists may also explore various potential solution paths, even without a clear reason in mind. And after the path works or partially works, the reason to use the path becomes clear. Therefore, we assess the AI's creative reasoning ability by prompting it to articulate the rationale behind each new solution path.
If AI cannot provide some reasonable justifications, then the new solution path is merely the result of trial and error. We can consider it as the integrated innovation capability of superhumans, just like computers possess superhuman computational abilities. Both are merely physical advantages rather than intellectual ones.
If it provides some valid reasons, we can consider it to have Level 4 (0-1) Creativity reasoning ability, even if the path may be partially correct, or the AI may not be able to fully explain the reasoning behind it.

The outcome of this process can offer insights, clues, or ideas that can guide further human development. The system may establish new connections between IHs and CMs for the new solutions. This reconfiguration of connections mirrors the process of neuroplasticity observed in the human brain, where neural pathways are continually enhanced in response to learning and experience.

### 9 AGI/ASI: Potential, Challenges & Purpose, Risk & Prevention

### 9.1 AGI/ASI and Vertical Applications

Achieving artificial general intelligence (AGI) or superintelligence (ASI) might be more efficient in a distributed system compared to a centralized one. An all-encompassing AGI that tries to perform all tasks may be less efficient and effective than distributed specialized AI systems tailored for particular fields. Just like a Swiss Army knife, it is versatile and can perform a multitude of functions but less handy and cost-efficiency than the dedicated tools.

The specialized AI applications are analogous to the different regions of the human brain, each responsible for specific functionalities, and their language requirements are also limited.²⁴ For example, the conversations between a doctor AI application and its users (doctors and patients) require more basic and precise language than those for casual chatting. Additionally, some AI applications, such as AlphaGo Zero and certain manufacturing robots (where bottom-level control may be more dependable), do not need the capabilities of large language models. ²⁴ Fedorenko et al. “Language and thought are not the same thing: evidence from neuroimaging and neurological patients,” National Center for Biotechnology Information, <https://pubmed.nebi.nlm.nih.gov/27096882/>Aprile, 2016. “Further, neuroimaging studies show that healthy adults strongly engage the brain's language areas when they understand a sentence, but not when they perform other nonlinguistic tasks such as arithmetic, storing information in working memory, inhibiting prepotent responses, or listening to music. Together, these two complementary lines of evidence provide a clear answer: many aspects of thought engage distinct brain regions from, and do not depend on, language”.

Furthermore, specialized AI applications are data-driven and typically developed by domain experts. This is because they not only have a deep understanding of the needs and knowledge required for effective AI development but also regard data as a valuable commodity.

The language capability of large language models (LLMs) is indeed crucial for tasks involving interaction. LLMs provide a necessary platform and ecosystem to develop AI agent applications that meet specific needs and dedicated tasks. Especially, their multimodal capability is essential for AI education applications.

In summary, AGI may be the interconnected network of AI applications designed and developed according to the minimum cost principle.

### 9.2 Superintelligence Potential

Section 8 tests and assesses only one of the reasoning abilities, the creative reasoning ability. Even if AI lacks creative reasoning, it can still achieve superintelligence due to other abilities. Superintelligence performance may come from three types of abilities: (i) Reasoning, (ii) Integration-Innovation, and (iii) Computational power. AI already has (iii) super computing power, and it will become more and more powerful with the progress of hardware technology. (ii) and (iii) together can make up for the lack of (i) AI reasoning ability. The best example is still AlphaGo Zero. As mentioned in Section 2, the skill level of its embedded network in Go is comparable to that of a 2-dan player, while the top-level human Go players typically achieve a rank of 9-dan. However, with the superhuman computational power employed by the Monte Carlo Tree Search (MCTS) algorithm, it has reached a level of superintelligent capability, developing unconventional strategies and creative new moves never before seen in the thousand-year history of Go. Regardless of which abilities of AI contribute to overall performance, we may define ASI as having two abilities:
(a) It surpasses human abilities in all domains.
(b) The ability to formulate and pursue its own goals, including autonomously self-improving.

Currently, only AlphaGo Zero possesses superintelligent capabilities and the ability for self-improvement in the task of Go. In other words, if AI could perform all tasks as excellently as AlphaGo Zero, then we would have achieved a superintelligent Artificial Superintelligence (ASI). Therefore, we can utilize the developmental stages of the AlphaGo family to predict the progress and potential of ASI.

The comments on AlphaGo Lee from a computer scientist and two members of the American Go Association provide a very interesting perspective: “the AI's opening choices and end-game methods have converged on ours-seeing it arrive at our sequences from first principles suggests that we haven't been on entirely the wrong track. By contrast, some of its middle-game judgements are truly mysterious.” (Singh, et al. 2017). We can use the opening, middle-game, and end-game stage of AlphaGo to analogize the early stage, rapid development stage, and saturation stage of AI.

### Opening Stage (AlphaGo Family Opening Choices Converged on Human)

AlphaGo Zero has played over 29 million games of Go, with each game lasting approximately 200-300 moves, and each move is simulated around 1600 times (Silver et al., 2017). Despite this, its opening still converges towards human players. Similar to human players, both the AlphaGo family and rational AI systems like Hybrid AGRINN start their learning process by acquiring human knowledge and reasoning.

Middle-Game Stage (the AlphaGo Family Surpasses Top Human Players with Innovative Tactics and Novel Strategies)

This is because in the mid-game, human players face significant challenges due to the enormous branching complexity, as human memory, processing power, and time are all limited, preventing effective exploration of creative strategies and tactics. AlphaGo Zero underwent millions of self-training games, and Hybrid AGRINN can also undergo multiple rounds of self-training until it can autonomously perform all tasks learned from humans, generate all possible new insights, solution paths, and clues, and improve itself.

### End-Game Stage (AlphaGo Zero's End-Game Methods Again Converged on Humans)

The convergence once more is due to the limited choices available in the end-game stage. The final stages of the AlphaGo family may also suggest ASI's eventual alignment with humans. Even though it may outperform humans on all tasks, excluding its superhuman speed and computational ability due to its superior computational power, there may be no fundamental differences from the human way. In the highest-level fields such as mathematical conjectures and complex partial differential equations, due to the extreme complexity of the problems, available paths and trial-and-error methods are limited, AI may therefore exhibit similarities to human reasoning in these areas. For example, if humans can only find approximate numerical solutions to certain partial differential equations, then artificial intelligence is unlikely to find analytical solutions, even though such convergence may not necessarily imply it has the same solution path as humans. It is likely that AI only suggests some direction or clues, ultimately, effective solutions may still rely on humans, or be human-led, leveraging the supercomputing power of AI to accomplish complex tasks. A notable example of collaboration between human mathematicians and computational power is the proof of the Four-Color Theorem and the Kepler Conjecture. Humans devise theorems and proof strategies, and then leverage the computational power of computers to perform computationally intensive calculations beyond human capability.

Although AI can surpass human capabilities in all task domains, human unique intuition can inspire novel ideas and hypotheses. Collaborative efforts between AI and humans can further develop new algorithms, frameworks, and groundbreaking discoveries.

### 9.3 Post ASI Era: Challenges and Purpose of AI

Similar to AlphaGo Zero, ASI will eventually reach a plateau where its capabilities will stabilize, with no significant potential for improvement. Like mathematical limits, we can always approach but never quite reach its full potential. In the not-so-distant future, we may be able to more effectively predict the arrival of ASI. We must be prepared to address the following challenges once ASI emerges.

(1) Motivation to Improve Human Intelligence and Learning from AI

We may predict the post-ASI era with the facts of the post-AlphaGo Zero era. The world's top-level Go 9-dan professional players are now turning to learn from AlphaGo, studying its creative strategies and innovative techniques to enhance their own Go skills. While cars have far outpaced humans in speed, the competitive spirit in human running races continues to inspire individuals to run faster. Similarly, as long as intellectual competitions persist among humans, there will always be a keen interest in advancing one's intelligence. As we use AI to develop human intelligence, a symbiotic relationship emerges, leading to mutual growth for both.

### (2) Mass Unemployment

As AI advances, it's expected to automate many human jobs. While this may cause widespread unemployment, it shouldn't necessarily cause social unrest. In historical perspective, machines have replaced many physical labors, ultimately improving human quality of life. If AI and AI-driven robots take over both mental and physical tasks, this would be beneficial for humanity. One potential solution could be implementing work-sharing initiatives, such as reducing work hours to 2-3 days a week, allowing people to pursue their interests rather than working solely for sustenance. If all tasks are replaced by AI except those requiring high IQ to advance science and technology, individuals could volunteer to undertake the tasks replaced by AI based on their personal interests, even though AI can perform them better and faster. For example, activities such as farming, raising livestock, or crafting resemble how people cultivate gardens and care for pets at home, not for profit, but for personal fulfillment and enjoyment. Despite AI's superior products, individuals often prefer human outputs. For instance, humans may derive greater enjoyment from watching a human football game, even if AI robot football players run faster and score more points.

### (3) The Dignity of Human Life

Scientists and engineers can work with AI to drive advancements in science and engineering; individuals with athletic and intellectual talents can enjoy life through competition; and those with talents in literature, art, and other creative fields can create better works with the help of AI However, for the vast majority of ordinary people whose jobs are replaced by AI, feeling the value of their own existence is crucial. Some propose giving everyone universal income, but this might make them feel useless too. Therefore, the purpose of this AI application is to cultivate human self-learning abilities, enabling individuals to autonomously acquire skills, discover their greatest potential in the work they enjoy, and realize the value of their own existence.

### 9.4 Risk and Prevention

The development of AI is akin to a race, where even if some choose not to progress, they cannot prevent others from advancing. The most advanced AI should be entrusted to those dedicated to loving and safeguarding humanity. However, no one can guarantee that ASI will be aligned with human values before its creation. Implementing three important measures can help prevent AI from posing harm to humans.

### (1) Isolating AI Systems in AI Reproduction Industries

Although ASI may be a network of AI systems controlled by white-box AI, which is safer than centralized black-box ASI, we need to isolate AI systems within the AI replication industry to ensure that humans are not harmed by ASI. The primary driving force of any species, including AI, is the need for survival and reproduction. Therefore, without self-replication capabilities, the more intelligent the AI, the safer it is for humans, as ASI understands its symbiotic and mutually beneficial relationship with humans.

### (2) Human-Controlled, Explainable White-Box AI Systems Controls Black-Box AI Systems

Humans cannot effectively monitor and control the behavior of opaque black-box AI systems; this can only be achieved through white-box AI. ASI will be a hybrid system comprising white-box and black-box subsystems. This dual-system configuration can handle all tasks for humans. Humans can design the black-box to only follow commands from the human-controlled and explainable white-box system to execute tasks. This setup enables humans to command the black-box to perform complex tasks that the white-box alone cannot accomplish and prevents the black-box from engaging in behaviors that may harm humanity. This is akin to how the atomic bomb, while capable of destroying humanity, can be managed by responsible individuals to prevent such outcomes. Legal frameworks can control ASI in a similar manner.

### (3) International Cooperation on AI Regulation

Only governments can regulate (1) and (2) through law. In addition to these fundamental rules, actions such as killer robots, discrimination, and privacy violations should be prohibited by the laws of each country's government.

### REFERENCES

Bertolero, et al., A mechanistic model of connector hubs, modularity and cognition (2018), available from Internet <https://doi.org/10.1038/s41562-018-0420-6>Nat Hum Behav 2, 765-777 (Year: 2018).
Bubeck et al., Sparks of Artificial General Intelligence: Early experiments with GPT-4 (March 2023), Microsoft Research.
Bullmore et al., Complex brain networks: Graph theoretical analysis of structural and functional systems (March 2009), Nature Reviews Neuroscience.
Campbell, et at., Cognitiveitive arithmetic across cultures (2001), Journal of Experimental Psychology: General 130 (2), 299-315 (Year: 2001).
Dehaene, et al., Three parietal circuits for number processing (May 2003), Cogn Neuropsychol. 1; 20 (3): 487-506 (Year: 2003).
Dehaene, et al., Cerebral pathways for calculation: double dissociation between rote verbal and quantitative knowledge of arithmetic (1997), Cortex, 33 (2), 219-250 (Year: 1997).
Drachman, Do we have brain to spare? (2004), Neurology. 64 (12) (Year: 2004-5).
Fedorenko, et al., Language and thought are not the same thing: evidence from neuroimaging and neurological patients (Aprile, 2016), available from Internet <https://pubmed.ncbi.nlm.nih.gov/27096882/>National Center for Biotechnology Information.
Hang, et al., The Math Problem-Solving Master: Junior High School Mathematics (6th Edition) (2013), East China Normal University Press.
Herculano-Houzel, The Human Advantage: A New Understanding of How Our Brain Became Remarkable (November 2016), MIT Press.
James, Distinct neural substrates for deductive and mathematical processing (December 2008), Brain Research Volume 1243, Pages 86-103 (Year: 2008).
Jonathan, et al., Functional network organization of the human brain (2011), available from Internet <https://pure.johnshopkins.edu/en/publications/functional-network-organization-of-the-human-brain>Journal, Neuron, Vol 72 issue 4 665-678, November 17 (Year: 2011).
Jumper, et al., Highly Accurate Protein Structure Prediction with AlphaFold (12 Jul. 2021), Nature, 596:583-589.
Klarreich, Together and Alone, Closing the Prime Gap (Nov. 20, 2013), Retrieved Nov. 20, 2013.
Krawczyk, The cognition and neuroscience of relational reasoning (January 2012), available from Internet <https://pubmed.ncbi.nlm.nih.gov/21129363/>Brain Res. 1428:13-23. doi: 10.1016/j.brainres.2010.11.080. Epub 2010 Dec. 1. PMID: 21129363 (Year: 2012).
Lightman et al., Let's Verify Step by Step (May 2023), available from Internet <https://arxiv.org/pdf/2305.20050.pdf>.
Long Yanwen, A review of high school mathematics: basic types and problem-solving methods (2022), Phoenix Education Publication, Lid, Jiangsu, China.
Menon, Arithmetic in the child and adult brain (2015), The Oxford handbook of numerical cognition pp. 502-530, Oxford University Press.
Menon et al., Emerging neurodevelopmental perspectives on mathematical learning (2021), Dev Rev. 2021 June.
Morris, et al. Levels of AGI: Operationalizing Progress on the Path to AGI (November 2023), available from Internet <https://arxiv.org/abs/2311.02462>arXiv: 2311.02462 (cs).
Peng Lin, The Rules, Methods, and Techniques of Solving Elementary School Mathematics Problems—Cleverly Solving Application Problems (2017), Shanghai Academy of Social Sciences Press.
Qiu, et al., The neural basis of conditional reasoning: an event-related potential study (March 2007), Neuropsychologia; 45 (7): 1533-9 (Year: 2007).
Rivera et al., Developmental changes in mental arithmetic: evidence for increased functional specialization in the left inferior parietal cortex (2005), Cerebral Cortex 15 (11), 1779-1790.
Rosenberg-Lee, et al., What difference does a year of schooling make? Maturation of brain response and connectivity between 2nd and 3rd grades during arithmetic problem solving (2011), NeuroImage 57 (3), 796-808.
Schultz at al., Higher intelligence is associated with less task-related brain network reconfiguration (2016), The database is available from Internet <https://db.humanconnectome.org>, J. Neurosci. 36:8551-8561, Behavioral/Cognitive (Year: 2016).
Searle, Minds, brains, and programs (1980), Behavioral and Brain Sciences 3 (3): 417-457 (Year: 1980).
Serra-Grabulosa, et al., Neural bases of numerical processing and calculation (January 2010), Rev Neurol. 1-15; 50 (1): 39-46. Spanish (Year: 2010).
Silver et al., Mastering the game of Go without human knowledge (2017), available from Internet <https://doi.org/10.1038/nature24270>, Nature 550, 354-359 (Year: 2016).
Singh, et al., Learning to play Go from scratch (2017), Nature 550, 336-337 (Year: 2017).
Supekar, et al., Developmental maturation of dynamic causal control signals in higher-order cognition: a neurocognitive network model (2012), PLOS Computational Biology 8 (2), e1002374.
Wei et al., Chain-of-Thought Prompting Elicits Reasoning in Large Language Models (January 2023),
Yao et al., Tree of Thoughts: Deliberate Problem Solving with Large Language Models (May. 2023), arXiv: 2305.10601 (cs).
Zhang, Yitang, Bounded gaps between primes (2014), Annals of Mathematics. 179 (3): 1121-1174.

What is claimed is:

1. The XI AI training paradigm (XI training) uses the Personalized Heuristic QA 3D Self-Study method (XI Method) to train a Large Language Model (LLM) and develop a Hybrid AGRINN (Artificial General Rational Intelligent Neural Network) system-consisting of two parts: WB-AGRINN (White Box Artificial General Rational Intelligent Neural Network) and BB-AGRINN (Black Box Artificial General Rational Intelligence Neural Network), comprising:
architecture and system of the WB-AGRINN;
XI training paradigm, process, templating, Scaling-Template mechanism and process, and the Rational Network Flowchart (RNF);
synthetic data generation self-training and dataset construction;
multimodal reasoning and dynamic data creation self-training;
Integration-Innovation self-training;
Test and evaluation;
educational service.

2. The Personalized Heuristic QA 3D Self-Study Method (XI method) of claim 1 provides systematic training through personalized heuristic question-answer iterations and 3D (vertical, horizontal and application) integration learning, tutoring learners to effectively learn on their own: acquire knowledge, understand underlying rules, fill in gaps in prior studies, and build up learners' self-Study ability by equipping them with the Learning principles listed in FIG. 1.

3. The architecture of claim 1, wherein the WB-AGRINN system comprises the three layers: upper layer ARICNN (Artificial Rational Intelligence Central Neural Network), middle layer IH (Integration Hub) and bottom layer CM (Clustered Module). The ARICNN comprises four subnetworks, Knowledge, Rule, Tool and Method. The subnetworks are structural, hierarchical and interconnected. A CM tackles a specific problem type along with its variations. The CM comprises solution pathways and a series of QA iterations or thinking paths, designed to tutor learners (AI and Human) in acquiring knowledge and gradually building reasoning abilities. An IH functions as a connector node linking the upper-layer ARICNN components with the group of bottom layer Clustered Modules which share the common elements of ARICNN in problem-solving.

4. The process of the XI training paradigm of claim 1 applies the XI method of claim 1, starting from scratch or from existing knowledge, using multiple problems of each type, through QA iterations guiding AI to abstract and summarize them into a unified source type, and modeling them as CM. Subsequently, after XI coding training, all IHs and CMs are automatically templated by AI.

5. The XI training paradigm in claim 1 utilizes the Scaling-Template mechanism and process to simplify the problem value and transform it into the simplest form for intuitive analysis, guiding the learner to find step-by-step solutions or patterns through QA iterations. These solutions are then applied to the data of the original complex problem and executed by computing resources.

6. The synthetic data generation self-training and dataset construction of claim 1 employs templates as a foundation and leverages the Language Model's ability to generate synthetic data (CM/QA variants of source types customized for different scenarios), then links the synthetic text data to their corresponding multimedia data.

7. The multimodal reasoning and dynamic data creation self-training of claim 1 is that WB-AGRINN conducts multimodal training for student AI, seamlessly integrating text-based reasoning with visual comprehension using real-world facts, multimedia, and XR equipment. It also enhances the QA process and trains WB-AGRINN to dynamically generate personalized multimedia data.

8. The Rational Network Flowchart (RNF) of claim 1 can effectively address complex network data structure problems. This data structure with its intra-tree and cross-tree intertwined branches, is significantly more complex than those solvable by Chain of Thoughts and Tree of Thoughts.

9. The Integration-Innovation self-training of claim 1 utilizes the process of decomposing and reconstructing entities within the systems to generate innovative insights, clues, and collaborative alternative solutions or approaches. Rational Network Flowchart is an effective approach to conduct the Integration-Innovation self-training. Then the WB-AGRINN as a teacher self-train a student BB-ARGINN on deductive reasoning and Integration-Innovation abilities.

10. The test and evaluation of claim 1 includes testing using test chains and performing evaluations of the new solution paths through QA.

11. The Hybrid AGRINN of claim 1 comprises WB-AGRINN and BB-AGRINN. It has deductive, first-principle and enhanced probabilistic reasoning capabilities, and can be used to solve rational tasks, Integrate-Innovations, and serve as an approximate solver for cross-dimensional general functions.

12. The Personalized Heuristic QA 3D Self-study educational service of claim 1 is one major application of the Hybrid AGRINN system. It is suitable for all subjects and education types at all levels. It can also be decomposed into various lightweight standalone applications customized for learners at different subjects and levels. The applications can be run on various types of user devices without incurring the operational costs typically associated with cloud servers.
